(19) United States
(12) Patent Application Publication
(10) Pub. No.: US 2023/0380500 A1
(43) Pub. Date: Nov. 30, 2023

(54) HEAT-NOT-BURN TOBACCO PRODUCT AND HEAT-NOT-BURN TOBACCO STICK

(71) Applicant: JAPAN TOBACCO INC., Tokyo (JP)

(72) Inventors: Manabu YAMADA, Tokyo (JP); Yasunobu INOUE, Tokyo (JP); Tateki SUMII, Tokyo (JP)

(73) Assignee: JAPAN TOBACCO INC., Tokyo (JP)

(21) Appl. No.: 18/233,168

(22) Filed: Aug. 11, 2023

Related U.S. Application Data
(63) Continuation of application No. PCT/JP2021/040088, filed on Oct. 29, 2021.

(30) Foreign Application Priority Data
Feb. 12, 2021 (WO) PCT/JP2021/005151

(51) Int. Cl. A24F 40/46; A24D 1/20; A24D 1/04; A24F 40/20; A24D 1/02; H05B 3/42

(52) U.S. Cl. CPC A24F 40/46; A24D 1/20; A24D 1/042; A24F 40/20; A24D 1/025; H05B 3/42

(57) ABSTRACT

This heat-not-burn tobacco product is provided with an electric heating device and a tobacco stick. The tobacco stick is provided with: a tobacco rod part having a tobacco filler containing cut tobacco; a mouthpiece part coaxially connected to the tobacco rod part; and a ventilation hole provided in the mouthpiece part. The electric heating device has a hollow piping heater having a heating chamber formed therein. The hollow piping heater has: a compression tube part that compresses the tobacco rod part from the outer circumferential side when the tobacco stick is inserted; and a heating wall part that is at least partially formed by the compression tube part and heats the tobacco rod part from the outer circumferential side.

### TECHNICAL FIELD

The present invention relates to a heat-not-burn tobacco product and a heat-not-burn tobacco stick.

### BACKGROUND ART

There is known a heat-not-burn tobacco product that includes an electric heating device and a heat-not-burn tobacco stick (see, for example, PTL 1). The electric heating device includes a heater assembly, a battery unit serving as an electric power supply of the heater assembly, a control unit that controls a heating element of the heater assembly, and the like. The heat-not-burn tobacco stick is used together with the electric heating device. In an example, the heat-not-burn tobacco stick includes a tobacco rod portion and a mouthpiece portion. The tobacco rod portion includes a tobacco filler and rolling paper. The tobacco filler includes a tobacco raw material (for example, shredded tobacco, tobacco granules, a molded body of tobacco sheet, or the like) and an aerosol generating source (glycerine, propylene glycol, or the like). The rolling paper wraps the tobacco filler. The mouthpiece portion is coaxially coupled to the tobacco rod portion when wrapped with tipping paper together with the tobacco rod portion.

When an electrically heated tobacco product is used, the heat-not-burn tobacco stick is inserted through an insertion port into a chamber of the heater assembly in the electric heating device, and the heating element of the heater assembly is caused to produce heat by using electric power supplied from the battery unit. As a result, the tobacco filler of the tobacco rod portion is heated, an aerosol is generated from the aerosol generating source included in the tobacco filler, and a flavor component is delivered to the inside of the mouth.

### CITATION LIST

### Patent Literature

PTL 1: International Publication No. 2017/198838

### SUMMARY OF INVENTION

### Technical Problem

As a heating system for a heat-not-burn tobacco stick using an electric heating device, there is known an outside heating system that a tobacco rod portion is heated from an outer peripheral side with a heater in which a heating element is disposed on an inner wall surface of a hollow tube defining a chamber of a heater assembly. In an electric heating device of such an outer heating system, it is important to improve heating efficiency by ensuring a contact state between the heater and the tobacco rod portion inserted in the chamber from the viewpoint of increasing the delivery amount of a flavor component.

However, when, for example, specifications to compress the tobacco rod portion inserted in the device-side chamber from the outer peripheral side with the inner wall surface of the chamber are intended to be adopted from the viewpoint of increasing the delivery amount of a flavor component in the heat-not-burn tobacco stick, insertion resistance occurs due to contact with the inner wall surface of the chamber before the tobacco stick is inserted to the prescribed location of the chamber, and, therefore, it may be difficult for a user to find that the distal end of the tobacco stick has reached the prescribed location of the chamber. Accordingly, when the tobacco stick is forcibly pushed in although the tobacco stick has reached the prescribed location of the chamber, the tobacco stick may buckle or collapse in the axial direction as a result of this action. On the other hand, the user may mistake that the tobacco stick has reached the prescribed location of the chamber although the tobacco stick has not reached the prescribed location and, therefore, stop insertion operation of the tobacco stick before the prescribed location of the chamber.

The present invention is contemplated in view of the above situation, and it is an object to provide a technology for ensuring the delivery amount of a flavor component in a heat-not-burn tobacco stick during inhalation and allow a user to easily find that the tobacco stick is inserted to a prescribed location of a chamber.

### Solution to Problem

A technology according to the present invention provides a heat-not-burn tobacco product. The heat-not-burn tobacco product includes an electric heating device, and a heat-not-burn tobacco stick used together with the electric heating device. The heat-not-burn tobacco stick includes a tobacco rod portion that includes a tobacco filler including shredded tobacco and rolling paper wrapping the tobacco filler, a mouthpiece portion coaxially coupled to the tobacco rod portion when wrapped with tipping paper together with the tobacco rod portion, and an air hole provided in the mouthpiece portion. The electric heating device includes a hollow tube heater defined so as to form a heating chamber inside, the heating chamber allowing the heat-not-burn tobacco stick to be inserted. The hollow tube heater includes a compression cylinder used to compress the tobacco rod portion from an outer peripheral side when the heat-not-burn tobacco stick is inserted, and a heating wall formed from at least part of the compression cylinder and used to heat the tobacco rod portion from the outer peripheral side. A cross-sectional area of the tobacco rod portion is relatively greater than an inner cross-sectional area of the compression cylinder and defined such that the tobacco rod portion inserted in the compression cylinder is compressed by an inner wall surface of the compression cylinder. A location of the air hole provided in the mouthpiece portion is defined so as to coincide with a location of an insertion port of the heating chamber when a distal end of the tobacco rod portion is inserted to a prescribed location of the heating chamber.

Here, the prescribed location may be a deepest location of the heating chamber.

In the heat-not-burn tobacco stick, part of an outer surface of the tipping paper may be coated with a lip-release material, and, of the outer surface of the tipping paper, a lip-release material region coated with the lip-release material may be defined as a region located adjacent to the insertion port with respect to at least the heating wall when a distal end of the tobacco rod portion is inserted to the prescribed location of the heating chamber. In this case, the lip-release material region may be a region located between the air hole and a mouthpiece end of the mouthpiece portion.

The cross-sectional area of the tobacco rod portion may be defined such that the cross-sectional area after insertion into the compression cylinder is greater than or equal to 60% and less than or equal to 99% of the cross-sectional area before insertion into the compression cylinder.

The compression cylinder may include a pair of opposite sandwiching walls extending along an axial direction of the compression cylinder, and the tobacco rod portion inserted in the compression cylinder may be configured to be compressed by inner wall surfaces of the sandwiching walls.

The inner wall surfaces of the pair of sandwiching walls may be opposed parallel to each other.

A diameter of the tobacco rod portion may be defined to a dimension greater than or equal to 105% and less than or equal to 200% of a space between the inner wall surfaces of the pair of sandwiching walls.

In the heat-not-burn tobacco product, in a state where the heat-not-burn tobacco stick is inserted to a prescribed location of the heating chamber, a whole of the tobacco rod portion and part of the mouthpiece portion may be configured to be compressed by the inner wall surface of the compression cylinder.

A cross-sectional area of the mouthpiece portion may be defined such that the cross-sectional area after insertion into the compression cylinder is greater than or equal to 60% and less than or equal to 99% of the cross-sectional area before insertion into the compression cylinder.

The present invention may be specified as a heat-not-burn tobacco stick used together with an electric heating device. In other words, the present invention provides a heat-not-burn tobacco stick used together with an electric heating device and heated from an outer peripheral side in a state of being inserted in a hollow tube heater defined such that a heating chamber of the electric heating device is formed inside. The heat-not-burn tobacco stick includes a tobacco rod portion that includes a tobacco filler including shredded tobacco and rolling paper wrapping the tobacco filler, a mouthpiece portion coaxially coupled to the tobacco rod portion when wrapped with tipping paper together with the tobacco rod portion, and an air hole provided in the mouthpiece portion. A cross-sectional area of the tobacco rod portion is relatively greater than an inner cross-sectional area of a compression cylinder of the hollow tube heater, the compression cylinder has a heating wall used to heat the tobacco rod portion from an outer peripheral side, the tobacco rod portion inserted in the compression cylinder is defined so as to be compressed by an inner wall surface of the compression cylinder. A location of the air hole provided in the mouthpiece portion is defined so as to coincide with a location of an insertion port of the heating chamber when a distal end of the tobacco rod portion is inserted to a prescribed location of the heating chamber.

Means for solving the problem according to the present invention may adopt combinations as much as possible.

### Advantageous Effects of Invention

According to the present invention, it is possible to provide a technology for ensuring the delivery amount of a flavor component in a heat-not-burn tobacco stick during inhalation and allow a user to easily find that the tobacco stick is inserted to a prescribed location of a chamber.

### BRIEF DESCRIPTION OF DRAWINGS

FIG. 1 is a perspective view of a tobacco stick according to an embodiment.

FIG. 2 is a view that illustrates the internal structure of the tobacco stick according to the embodiment.

FIG. 3 is an external appearance perspective view of an electric heating device according to the embodiment.

FIG. 4 is a view that illustrates the internal structure of the electric heating device according to the embodiment.

FIG. 5 is a perspective view of a hollow tube heater according to the embodiment.

FIG. 6 is a schematic longitudinal sectional view of the hollow tube heater according to the embodiment.

FIG. 7 is an exploded view of the hollow tube heater according to the embodiment.

FIG. 8 is a perspective view of a chamber tube according to the embodiment.

FIG. 9 is a view of a heating chamber in the hollow tube heater according to the embodiment when seen from an insertion port side.

FIG. 10 is a perspective view of a plug member according to the embodiment.

FIG. 11 is a cross-sectional view of the hollow tube heater, taken along the line A-A in FIG. 6.

FIG. 12 is a cross-sectional view of the hollow tube heater, taken along the line B-B in FIG. 6.

FIG. 13 is a view that illustrates a state where a tobacco stick is inserted to a prescribed location in the heating chamber of the electric heating device according to the embodiment.

### DESCRIPTION OF EMBODIMENTS

An embodiment of the heat-not-burn tobacco product and the heat-not-burn tobacco stick according to the present invention will be described with reference to the drawings. Sizes, materials, shapes, relative arrangement, and the like of component elements described in the present embodiment are one examples.

### EMBODIMENT

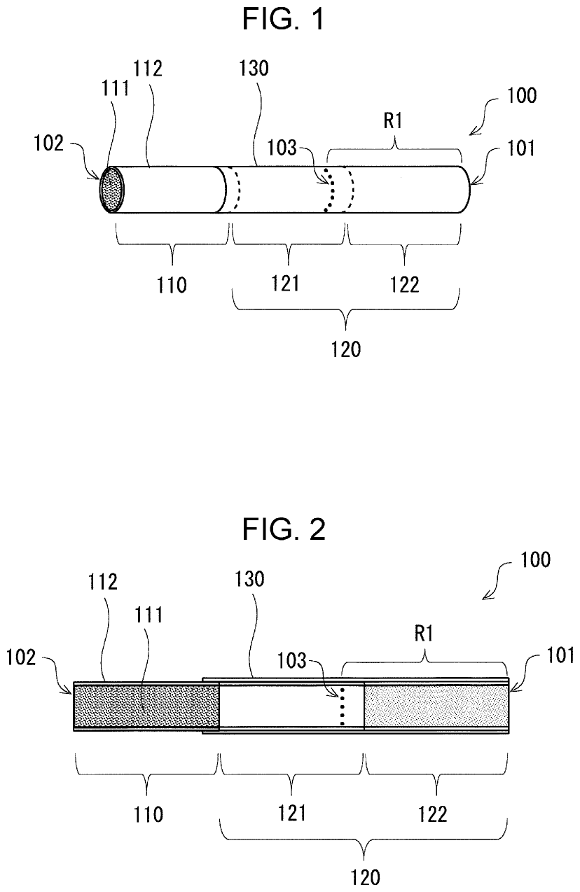

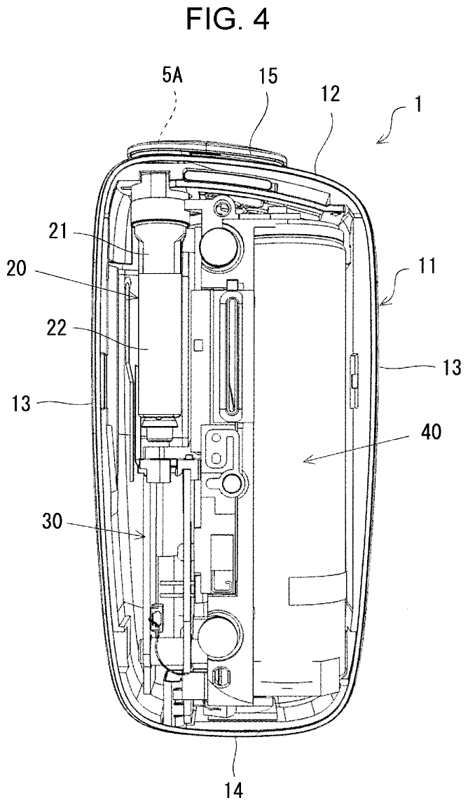

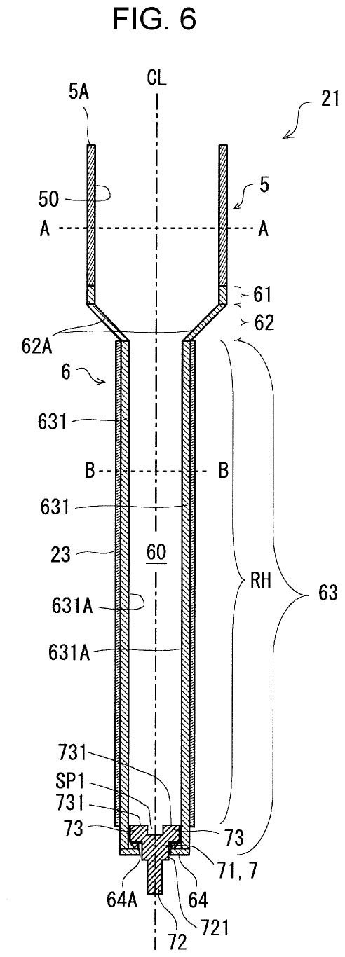

FIG. 1 is a perspective view of a heat-not-burn tobacco stick (hereinafter, simply referred to as “tobacco stick”) 100 according to the embodiment. FIG. 2 is a view that illustrates the internal structure of the tobacco stick 100 according to the embodiment. The tobacco stick 100 has a structure suitable to be used together with an electric heating device 1 (described later). A heat-not-burn tobacco product is made up of the electric heating device 1 and the tobacco stick 100. When the heat-not-burn tobacco product is used, the tobacco stick 100 is allowed to be inserted into a heating chamber 60 or removed from the heating chamber 60 through the insertion port (indicated by reference sign 5A in FIGS. 4, 6, and the like) of the electric heating device 1.

The tobacco stick 100 according to the embodiment has a substantially cylindrical rod form. In the example shown in FIGS. 1 and 2, the tobacco stick 100 includes a tobacco rod portion 110, a mouthpiece portion 120, and tipping paper 130 uniting them as one. The mouthpiece portion 120 is coaxially coupled to the tobacco rod portion 110 when wrapped with the tipping paper 130 together with the tobacco rod portion 110.

Reference sign 101 indicates a mouthpiece end of the tobacco stick 100 (mouthpiece portion 120). Reference sign 102 indicates a distal end of the tobacco stick 100 on an opposite side to the mouthpiece end 101. The tobacco rod portion 110 is disposed adjacent to the distal end 102 side in the tobacco stick 100. In the example shown in FIGS. 1 and 2, the tobacco stick 100 has a substantially constant diameter over the entire length in a longitudinal direction from the mouthpiece end 101 to the distal end 102.

[Tipping Paper]

The material of the tipping paper 130 is not limited. The material may be a paper made of general botanical fibers (pulp), a sheet using chemical fibers of polymers (polypropylene, polyethylene, nylon, or the like), a metal foil like an aluminum foil, or the like, or a composite material combining some of them. For example, the tipping paper 130 may be made of a composite material obtained by laminating a metal foil to a paper substrate. Here, the tipping paper 130 means a sheet material connecting a plurality of segments in the tobacco stick 100, for example, coupling the tobacco rod portion 110 to the mouthpiece portion 120.

The basis weight of the tipping paper 130 is not limited. The basis weight is commonly greater than or equal to 32 gsm and less than or equal to 40 gsm, preferably greater than or equal to 33 gsm and less than or equal to 39 gsm, and more preferably greater than or equal to 34 gsm and less than or equal to 38 gsm. The air permeability of the tipping paper 130 is not limited. The air permeability is commonly higher than or equal to 0 CORESTA Unit and lower than or equal to 30000 CORESTA Unit, and preferably higher than 0 CORESTA Unit and lower than or equal to 10000 CORESTA Unit. Air permeability is a value measured in compliant with ISO2965:2009, and indicates the flow rate (cm³) of gas that passes through an area 1 cm² per one minute when the pressure difference between both sides is 1 kPa. One CORESTA Unit (1 C.U.) is cm³/(min·cm²) under 1 kPa.

The tipping paper 130 may contain a filler in addition to the above-described pulp. Examples of the filler include a metal carbonate, such as calcium carbonate and magnesium carbonate, a metal oxide, such as titanium oxide, titanium dioxide, and aluminum oxide, a metal sulfate, such as barium sulfate and calcium sulfate, a metal sulfate, such as zinc sulfide, quartz, kaolin, talc, diatom earth, and gypsum. Particularly, the tipping paper 130 preferably contains calcium carbonate from the viewpoint of improving whiteness and opacity and increasing a heating rate. These fillers may be one type used solely or may be two or more types used in combination.

The tipping paper 130 may be added with various aids in addition to the above-described pulp and/or fillers and may have, for example, a water resistance improving agent for improvement. The water resistance improving agent includes a wet strength agent (WS agent) and a sizing agent. Examples of the wet strength agent include urea formaldehyde resin, melamine-formaldehyde resin, and polyamide-epichlorohydrin (PAE). Examples of the sizing agent include rosin soap, alkyl ketene dimer (AKD), alkenyl succinic anhydride (ASA), and high-saponification polyvinyl alcohol with a saponification degree of higher than or equal to 90%.

A coating agent may be added to at least one side of the two front and back sides of the tipping paper 130. The coating agent is not limited and is preferably a coating agent capable of forming a film on the surface of paper and reducing liquid permeability.

A manufacturing method for the tipping paper 130 is not limited. A general method may be applied. The manufacturing method may be, for example, in the case of a mode containing pulp as a main component, a method of uniforming formation in a paper-making process with a Fourdrinier paper machine, a cylinder paper machine, a cylinder-tanmo complex paper machine, or the like using pulp. Where necessary, a wet strength agent may be added to impart rolling paper with water resistance or a sizing agent may be added to adjust the printing condition of rolling paper.

<Tobacco Rod Portion>

The configuration of the tobacco rod portion 110 is not limited and may be a general mode. For example, the one in which a tobacco filler 111 is wrapped with rolling paper 112 may be used.

[Tobacco Filler]

In the present embodiment, the tobacco filler 111 is configured to contain shredded tobacco. The material of shredded tobacco contained in the tobacco filler 111 is not limited and may be a known one, such as lamina and a midrib, may be used. Alternatively, the material of shredded tobacco may be the one obtained by grinding dried tobacco leaves into ground tobacco with an average particle diameter greater than or equal to 20 μm and less than or equal to 200 μm, forming a sheet from the uniformed ground tobacco (hereinafter, also simply referred to as uniform sheet), and then shredding the uniform sheet. Alternatively, the material of shredded tobacco may be a so-called strand type in which the one obtained by shredding a uniform sheet, having a length equivalent to that of a tobacco rod in the longitudinal direction, substantially horizontally to the longitudinal direction of the tobacco rod is filled into the tobacco rod. The width of shredded tobacco is preferably greater than or equal to 0.5 mm and less than or equal to 2.0 mm for the purpose of being filled into the tobacco rod portion 110. The content of dried tobacco leaves contained in the tobacco rod portion 110 is not limited. The content of the dried tobacco leaves may be greater than or equal to 200 mg/rod portion and less than or equal to 800 mg/rod portion and preferably greater than or equal to 250 mg/rod portion and less than or equal to 600 mg/rod portion. This range is particularly suitable for the tobacco rod portion 110 with a circumference of 22 mm and a length of 20 mm.

As for tobacco leaves used to manufacture the shredded tobacco or the uniform sheet, various types of tobacco may be used. Examples of the types of tobacco include a flue cured type, a burley type, an orient type, a local type, other Nicotiana-tabacum-series species, Nicotiana-rustica-series species, and mixtures of them. The mixtures may be used by appropriately blending the above-described species to attain an intended taste. The details of the species of the tobaccos are disclosed in “Tobacco Dictionary, Tobacco Research Center, 2009.3.31”. There is a plurality of existing methods for the method of manufacturing a uniform sheet, that is, a method of grinding tobacco leaves and working the ground tobacco leaves into a uniform sheet. The first one is a method of manufacturing a paper-made sheet by using a paper-making process. The second one is a method of casting a uniformed product onto a metal plate or a metal plate belt with a thin thickness after an appropriate solvent, such as water, is mixed with the ground tobacco leaves to be uniformed and drying the uniformed product to form a cast sheet. The third one is a method of manufacturing a calendared sheet by extruding a product obtained by mixing an appropriate solvent, such as water, with the ground tobacco leaves and uniformed, into a sheet. The type of the uniform sheet is disclosed in detail in “Tobacco Dictionary, Tobacco Research Center, 2009.3.31”.

The moisture content of the tobacco filler 111 may be higher than or equal to 10 wt % and lower than or equal to 15 wt % with respect to the total amount of the tobacco filler 111 and preferably higher than or equal to 11 wt % and lower than or equal to 13 wt %. With such a moisture content, occurrence of wrapping stains is reduced, and machinability in manufacturing the tobacco rod portion 110 is improved. The size of shredded tobacco contained in the tobacco filler 111 and its preparation method are not limited. For example, the dried tobacco leaves may be the one shredded into a width greater than or equal to 0.5 mm and less than or equal to 2.0 mm. When a ground product of uniform sheet is used, dried tobacco leaves are ground into an average particle diameter of about 20 μm to about 200 μm, a sheet is formed from the uniformed ground product, and the one obtained by shredding the sheet into a width of greater than or equal to 0.5 mm and less than or equal to 2.0 mm may be used.

The tobacco filler 111 may contain an aerosol-source material that generates aerosol smoke. The type of the aerosol-source material is not limited. Extracted substances from various natural products and/or components of them may be selected according to an application. Examples of the aerosol-source material include glycerine, propylene glycol, triacetin, 1,3-butanediol, and mixtures of them. The content of the aerosol-source material in the tobacco filler 111 is not limited. From the viewpoint of sufficiently generating an aerosol and imparting a good flavor, the content of the aerosol-source material is commonly higher than or equal to 5 wt % and preferably higher than or equal to 10 wt % with respect to the total amount of the tobacco filler, and may be commonly lower than or equal to 50 wt % and preferably higher than or equal to 15 wt % and lower than or equal to 25 wt %.

The tobacco filler 111 may contain a flavoring agent. The type of the flavoring agent is not limited. From the viewpoint of imparting a good flavor, examples of the type of the flavoring agent include acetanisole, acetophenone, acetyl pyrazine, 2-acetyl thiazole, alfalfa extract, amyl alcohol, amyl butyrate, trans-anethole, star anise oil, apple juice, Peru balsam oil, beeswax absolute, benzaldehyde, benzoin resinoid, benzyl alcohol, benzyl benzoate, benzyl phenyl acetate, benzyl propionate, 2,3-butanedione, 2-butanol, butyl butyrate, butyric acid, caramel, cardamom oil, carob absolute, β-carotene, carrot juice, L-carvone, β-caryophyllene, cassia bark oil, cedar wood oil, celery seed oil, chamomile oil, cinnamaldehyde, cinnamic acid, cinnamyl alcohol, cinnamyl cinnamate, citronella oil, DL-citronellol, clary sage extract, cocoa, coffee, cognac oil, coriander oil, cuminaldehyde, davana oil, δ-decalactone, γ-decalactone, decanoic acid, dill herb oil, 3,4-dimethyl-1,2-cyclopentanedione, 4,5-dimethyl-3-hydroxy-2,5-dihydrofuran-2-one, 3,7-dimethyl-6-octenoic acid, 2,3-dimethyl pyrazine, 2,5-dimethyl pyrazine, 2,6-dimethyl pyrazine, ethyl 2-methyl butyrate, ethyl acetate, ethyl butyrate, ethyl hexanoate, ethyl isovalerate, ethyl lactate, ethyl laurate, ethyl levulinate, ethyl maltol, ethyl octanoate, ethyl oleate, ethyl palmitate, ethyl phenylacetate, ethyl propionate, ethyl stearate, ethyl valerate, ethyl vanillin, ethyl vanillin glucoside, 2-ethyl-3, (5 or 6)-dimethyl pyrazine, 5-ethyl-3-hydroxy-4-methyl-2(5H)-furanone, 2-ethyl-3-methyl pyrazine, eucalyptol, fenugreek absolute, gene absolute, gentian root infusion, geraniol, geranyl acetate, grape juice, guaiacol, guava extract, γ-heptalactone, γ-hexalactone, hexanoic acid, cis-3-hexen-1-ol, hexyl acetate, hexyl alcohol, hexyl phenylacetate, honey, 4-hydroxy-3-pentenoic acid lactone, 4-hydroxy-4-(3-hydroxy-1-butenyl)-3,5,5-trimethyl-2-cyclohexen-1-one, 4-(para-hydroxyphenyl)-2-butanone, sodium 4-hydroxy decanoate, immortelle absolute, β-ionone, isoamyl acetate, isoamyl butyrate, isoamyl phenyl acetate, isobutyl acetate, isobutyl phenylacetate, jasmine absolute, kola nut tincture, labdanum oil, lemon terpenless oil, licorice extract, linalool, linalyl acetate, lovage root oil, maltol, maple syrup, menthol, menthone, L-menthyl acetate, para-methoxy benzaldehyde, methyl-2-pyrrolyl ketone, methyl anthranilate, methyl phenylacetate, methyl salicylate, 4′-methyl acetophenone, methyl cyclopentenolone, 3-metnylvaleric acid, mimosa absolute, molasses, myristic acid, nerol, nerolidol, γ-nonalactone, nutmeg oil, δ-octalactone, octanal, octanoic acid, orange flower oil, orange oil, orris root oil, palmitic acid, ω-pentadecalactone, peppermint oil, petitgrain Paraguay oil, phenethyl alcohol, phenethyl phenylacetate, phenylacetic acid, piperonal, plum extract, propenyl guaethol, propyl acetate, 3-propylidenephthalide, prune juice, pyruvic acid, raisin extract, rose oil, rum, sage oil, sandalwood oil, spearmint oil, styrax absolute, marigold oil, tea distillate, α-terpineol, terpinyl acetate, 5,6,7,8-tetrahydroquinoxaline, 1,5,5,9-tetramethyl-13-oxacyclo (8.3.0.0(4.9)) tridecane, 2,3,5,6-tetramethyl pyrazine, thyme oil, tomato extract, 2-tridecanone, triethyl citrate, 4-(2,6,6-trimethyl-1-cyclohexenyl) 2-butene-4-one, 2,6,6-trimethyl-2-cyclohexen-1,4-dione, 4-(2,6,6-trimethyl-1,3-cyclohexadienyl) 2-butene-4-one, 2,3,5-trimethyl pyrazine, γ-undecalactone, γ-valerolactone, vanilla extract, vanillin, veratraldehyde, violet leaf absolute, N-ethyl-p-menthane-3-carboxamide (WS-3), and ethyl-2-(p-menthane-3-carboxamide) acetate (WS-5). Particularly, the type of the flavoring agent is preferably menthol. One type of these flavor agents may be used solely or two or more types may be used in combination.

The content of the flavoring agent in the tobacco filler 111 is not limited. From the viewpoint of imparting a good flavor, the content of the flavoring agent is commonly higher than or equal to 10000 ppm, preferably higher than or equal to 20000 ppm, and more preferably higher than or equal to 25000 ppm, and the content of the flavoring agent is commonly lower than or equal to 70000 ppm, preferably lower than or equal to 50000 ppm, more preferably lower than or equal to 40000 ppm, and further preferably lower than or equal to 33000 ppm.

[Rolling Paper]

The rolling paper 112 is a sheet material for wrapping the tobacco filler 111. The configuration of the rolling paper 112 is not limited, and a general sheet material may be used. For example, cellulose fiber paper may be used as base paper used for the rolling paper 112. More specifically, hemp, wood, or a mixture of them may be used. The basis weight of the base paper in the rolling paper 112 is, for example, commonly greater than or equal to 20 gsm and preferably greater than or equal to 25 gsm. On the other hand, the basis weight is commonly less than or equal to 65 gsm, preferably less than or equal to 50 gsm, and more preferably less than or equal to 45 gsm. The thickness of the rolling paper 112 having the above characteristics is not limited. From the viewpoint of stiffness, air permeability, and easiness of adjustment during paper manufacturing, the thickness of the rolling paper 112 is commonly greater than or equal to 10 μm, preferably greater than or equal to 20 μm, and more preferably greater than or equal to 30 μm, and the thickness of the rolling paper 112 is commonly less than or equal to 100 μm, preferably less than or equal to 75 μm, and more preferably less than or equal to 50 μm.

Examples of the shape of the rolling paper 112 of the tobacco rod portion 110 (tobacco filler 111) include a square shape and a rectangular shape. When used as the rolling paper 112 for wrapping the tobacco filler 111 (manufacturing the tobacco rod portion 110), the length of one side may range from about 12 mm to about 70 mm, the length of another one side may range from 15 mm to 28 mm, the preferred length of further another one side may range from 22 mm to 24 mm, and the further preferred length may be about 23 mm.

In addition to the above-described pulp, the rolling paper 112 may contain a filler. The content of the filler may be higher than or equal to 10 wt % and lower than 60 wt % and preferably higher than or equal to 15 wt % and lower than or equal to 45 wt % with respect to the total weight of the rolling paper 112. In the rolling paper 112, the filler is preferably higher than or equal to 15 wt % and lower than or equal to 45 wt % within the preferable basis weight range (greater than or equal to 25 gsm and less than or equal to 45 gsm). Furthermore, when the basis weight is greater than or equal to 25 gsm and less than or equal to 35 gsm, the filler is preferably higher than or equal to 15 wt % and lower than or equal to 45 wt %. When the basis weight is greater than 35 gsm and less than or equal to 45 gsm, the filler is preferably higher than or equal to 25 wt % and lower than or equal to 45 wt %. Examples of the filler include calcium carbonate, titanium dioxide, and kaolin. From the viewpoint of enhancing flavor and whiteness, or other viewpoints, calcium carbonate is preferably used.

The rolling paper 112 may be added with various aids in addition to base paper and a filler and may be added with, for example, a water resistance improving agent for improvement in water resistance. The water resistance improving agent includes a wet strength agent (WS agent) and a sizing agent. Examples of the wet strength agent include urea formaldehyde resin, melamine-formaldehyde resin, and polyamide-epichlorohydrin (PAE). Examples of the sizing agent include rosin soap, alkyl ketene dimer (AKD), alkenyl succinic anhydride (ASA), and high-saponification polyvinyl alcohol with a saponification degree of higher than or equal to 90%. A paper strengthening agent may be added as an aid. Examples of the paper strengthening agent include polyacrylamide, cationic starch, oxidized starch, CMC, polyamide epichlorohydrin resin, and polyvinyl alcohol. Particularly, as for oxidized starch, it is known that air permeability improves when a very small amount is used (for example, Japanese Unexamined Patent Application Publication No. 2017-218699). The rolling paper 112 may be coated as needed.

A coating agent may be added to at least one side of the two front and back sides of the rolling paper 112. The coating agent is not limited and is preferably a coating agent capable of forming a film on the surface of paper and reducing liquid permeability. Examples of the coating agent include polysaccharides, such as alginic acid and its salts (for example, sodium salt), and pectin, cellulose derivatives, such as ethyl cellulose, methyl cellulose, carboxymethyl cellulose, and nitrocellulose, and starches and their derivatives (for example, ether derivatives, such as carboxymethyl starch, hydroxyalkyl starch, and cationic starch, and ester derivatives, such as starch acetate, starch phosphate, and starch octenyl succinate).

In the tobacco rod portion 110 configured as described above, the tobacco filler 111 is wrapped with the rolling paper 112 in a state where shredded tobacco is randomly aligned. The state where shredded tobacco is randomly aligned means that the shredded tobacco is not wrapped with the rolling paper 112 in a state of being aligned in a specific direction. The axial length of the tobacco rod portion 110 can be changed as needed according to the size of a product. The axial length of the tobacco rod portion 110 is commonly greater than or equal to 10 mm, preferably greater than or equal to 12 mm, more preferably greater than or equal to 15 mm, and further preferably greater than or equal to 18 mm, and the axial length of the tobacco rod portion 110 is commonly less than or equal to 70 mm, preferably less than or equal to 50 mm, more preferably less than or equal to 30 mm, and further preferably less than or equal to 25 mm.

<Mouthpiece Portion>

The configuration of the tobacco stick 100 is not limited and may be a general mode. In the mode shown in FIG. 1, the mouthpiece portion 120 includes two segments, that is, a cooling segment 121 and a filter segment 122. The cooling segment 121 is disposed so as to be sandwiched between the tobacco rod portion 110 and the filter segment 122 in a state of being in contact with the tobacco rod portion 110 and the filter segment 122. In another mode, a space may be formed between the tobacco rod portion 110 and the cooling segment 121 and between the tobacco rod portion 110 and the filter segment 122. The mouthpiece portion 120 may be made up of a single segment.

[Cooling Segment]

The configuration of the cooling segment 121 is not limited as long as the cooling segment 121 has a function to cool tobacco mainstream smoke. Examples of the cooling segment 121 include the one formed by working thick paper into a cylindrical shape. In this case, the inside of the cylindrical shape is a cavity, and vapor containing an aerosol-source material and a tobacco flavor component contact with air in the cavity to be cooled.

Air holes 103 that are perforations for taking in air from an outside are provided in the cooling segment 121. The number of the air holes 103 in the cooling segment 121 is not limited. In the present embodiment, the plurality of air holes 103 is disposed at regular intervals in a circumferential direction of the cooling segment 121. A plurality of groups of the air holes 103 arranged in the circumferential direction of the cooling segment 121 may be formed along the axial direction of the cooling segment 121. Since the cooling segment 121 has the air holes 103, when the tobacco stick 100 is inhaled, low-temperature air flows from the outside into the cooling segment 121 to make it possible to decrease the temperatures of a volatile component and air flowing in from the tobacco rod portion 110. Vapor containing an aerosol-source material and a tobacco flavor component is cooled to condense by the low-temperature air introduced into the cooling segment 121 through the air holes 103. Thus, generation of an aerosol is facilitated, and the size of aerosol particles can be controlled.

When a sheet or the like for cooling a volatile component and air flowing from the tobacco rod portion 110 into the cooling segment 121 is filled in the cooling segment 121, the total surface area of the cooling segment 121 is not limited and may be, for example, greater than or equal to 300 mm²/mm and less than or equal to 1000 mm²/mm. The surface area is a surface area per length (mm) of the cooling segment 121 in a ventilation direction. The total surface area of the cooling segment 121 is preferably greater than or equal to 400 mm²/mm and more preferably greater than or equal to 450 mm²/mm, while the total surface area of the cooling segment 121 is preferably less than or equal to 600 mm²/mm and more preferably less than or equal to 550 mm²/mm.

The internal structure of the cooling segment 121 desirably has a large total surface area. Therefore, in a preferred embodiment, the cooling segment 121 may be provided with ridges and grooves to form channels and then may be made up of a sheet of a thin material formed with pleated, gathered, or folded. When there are many folds or pleats in a given volume of an element, the total surface area of the cooling segment 121 increases. The thickness of the constituent material of the cooling segment 121 is not limited and, for example, may be greater than or equal to 5 μm and less than or equal to 500 μm or may be greater than or equal to 10 μm and less than or equal to 250 μm.

The air holes 103 in the cooling segment 121 are preferably disposed at a location 4 mm or longer away from the boundary between the cooling segment 121 and the filter segment 122. Thus, it is possible to not only improve the cooling capacity of the cooling segment 121 but also suppress stagnation of a component generated by heating in the cooling segment 121 to improve the delivery amount of the component. The tipping paper 130 preferably has perforations at locations just above the air holes 103 (locations overlapping up and down) provided in the cooling segment 121. The perforations of the cooling segment 121 are preferably provided such that an air inflow rate through the perforations (a volume percent of air flowing in through the perforations where the percent of air inhaled from a mouthpiece end is 100 vol %) when inhaled with an automatic smoking machine at 17.5 ml/s ranges from 10 vol % to 90 vol %, preferably ranges from 50 vol % to 80 vol %, and more preferably ranges from 55 vol % to 75 vol %. For example, the number of perforations V per perforation group is selected from the range of five to 50, the diameter of each perforation V is selected from the range of 0.1 mm to 0.5 mm, and the above configuration is achieved by a combination of these selections. The air inflow rate can be measured with a method compliant with ISO9512 with an automatic smoking machine (for example, a single-barreling automatic smoking machine manufactured by Borgwaldt). The axial length of the cooling segment 121 is not limited. The axial length of the cooling segment 121 is commonly greater than or equal to 10 mm and preferably greater than or equal to 15 mm, and the axial length of the cooling segment 121 is commonly less than or equal to 40 mm, preferably less than or equal to 35 mm, and more preferably less than or equal to 30 mm. The axial length of the cooling segment 121 is particularly preferably set to 20 mm. When the axial length of the cooling segment 121 is greater than or equal to the lower limit, it is possible to ensure a sufficient cooling effect to obtain a good flavor. When the axial length of the cooling segment 121 is less than or equal to the upper limit, it is possible to suppress losses due to adhesion of vapor and aerosol generated during use to an inner wall of the cooling segment 121.

[Filter Segment]

The configuration of the filter segment 122 is not limited as long as the filter segment 122 has the function of a general filter. Examples of the filter segment 122 include the one formed by working cellulose acetate tow into a cylindrical columnar shape. The filament denier and total denier of cellulose acetate tow are not limited. When the filter segment 122 has a circumference of 22 mm, preferably, the filament denier ranges from 5 g/9000 m to 20 g/9000 m, and the total denier ranges from 12000 g/9000 m to 30000 g/9000 m. The sectional shape of fiber of cellulose acetate tow may be a Y section or may be an R section. In the case where the filter segment 122 is formed by being filled with cellulose acetate tow, 5 wt % or higher and 10 wt % or lower of triacetin may be added to the weight of cellulose acetate tow to improve filter hardness. In the example shown in FIG. 2, the filter segment 122 is made up of a single segment. Alternatively, the filter segment 122 may be made up of a plurality of segments. When the filter segment 122 is made up of a plurality of segments, for example, a mode in which a hollow segment, such as a center hole, is disposed on an upstream side (tobacco rod portion 110 side) and an acetate filter in which an inhalation port section is filled with cellulose acetate tow is disposed as a downstream (mouthpiece end 101 side) segment may be provided. With such a mode, it is possible to reduce useless losses of aerosol generated and provide a good external appearance of the tobacco stick 100. From the viewpoint of a change in feeling of satisfactory inhalation and mouthfeel, a mode in which an acetate filter is disposed on an upstream side (tobacco rod portion 110 side) and a hollow segment, such as a center hole, is disposed on a downstream side (mouthpiece end 101 side) may be adopted. The filter segment 122 may be made from another alternative filter material, such as a paper filter filled with sheet pulp paper, instead of the acetate filter.

Examples of a general function of the filter in the filter segment 122 include adjusting the amount of air to be mixed when an aerosol and the like are inhaled, reducing a flavor, and reducing nicotine and tar; however, the filter does not need to have all of these functions. In an electrically heated tobacco product that tends to have a smaller amount of component generated and a lower packing fraction of tobacco filler as compared to a cigarette product, it is also one of important functions to reduce falling of tobacco filler while suppressing a filtering function.

The cross-sectional shape of the filter segment 122 is substantially a circular shape, and the diameter of the circle can be changed as needed according to the size of a product. The diameter of the circle is commonly greater than or equal to 4.0 mm and less than or equal to 9.0 mm, preferably greater than or equal to 4.5 mm and less than or equal to 8.5 mm, and more preferably greater than or equal to 5.0 mm and less than or equal to 8.0 mm. When the section is not in a circular shape, a diameter of a circle having the same area as the area of the section is applied as the diameter. The circumference of the filter segment 122 can be changed as needed according to the size of a product. The circumference of the filter segment 122 is commonly greater than or equal to 14.0 mm and less than or equal to 27.0 mm, preferably greater than or equal to 15.0 mm and less than or equal to 26.0 mm, and more preferably greater than or equal to 16.0 mm and less than or equal to 25.0 mm. The axial length of the filter segment 122 can be changed as needed according to the size of a product. The axial length of the filter segment 122 is commonly greater than or equal to 15 mm and less than or equal to 35 mm, preferably greater than or equal to 17.5 mm and less than or equal to 32.5 mm, and more preferably greater than or equal to 20.0 mm and less than or equal to 30.0 mm. The shape and dimensions of a filter element may be adjusted as needed such that the shape and dimensions of the filter segment 122 respectively fall within the above-described ranges.

The air-flow resistance of the filter segment 122 per axial length 120 mm is not limited. The air-flow resistance of the filter segment 122 is commonly higher than or equal to 40 mmH₂O and lower than or equal to 300 mmH₂O, preferably higher than or equal to 70 mmH₂O and lower than or equal to 280 mmH₂O, and more preferably higher than or equal to 90 mmH₂O and lower than or equal to 260 mmH₂O. The air-flow resistance is measured with, for example, a filter air-flow resistance measuring device made by Cerulean in compliant with an ISO standard method (ISO6565). The air-flow resistance of the filter segment 122 indicates a difference in air pressure between a first end surface and a second end surface when air is flowed at a predetermined air flow rate (17.5 cc/min) from one end surface (first end surface) to the other end surface (second end surface) in a state where permeation of air does not occur at the side of the filter segment 122. The air-flow resistance can be generally expressed in mmH₂O. It is known that the relationship between the air-flow resistance of the filter segment 122 and the length of the filter segment 122 is a proportional relationship in an ordinarily used length range (a length of 5 mm to 200 mm). When the length of the filter segment 122 is doubled, the air-flow resistance is also doubled.

The density of the filter element in the filter segment 122 is not limited. The density of the filter element is commonly greater than or equal to 0.10 g/cm³ and less than or equal to 0.25 g/cm³, preferably greater than or equal to 0.11 g/cm³ and less than or equal to 0.24 g/cm³, and more preferably greater than or equal to 0.12 g/cm³ and less than or equal to 0.23 g/cm³. The filter segment 122 may include wrapping paper (filter plug wrapping paper) that wraps a filter element and the like from the viewpoint of improvement in strength and structural stiffness. The mode of wrapping paper is not limited and may include a joint including one or more lines of an adhesive. The adhesive may contain a hot-melt adhesive. In addition, the hot-melt adhesive can contain polyvinyl alcohol. When the filter segment 122 is made up of two or more segments, wrapping paper preferably wraps these two or more segments together. The material of wrapping paper in the filter segment 122 is not limited. A known material may be used. Also, the material of wrapping paper may contain a filler, such as calcium carbonate, or the like.

The thickness of wrapping paper is not limited. The thickness of wrapping paper is commonly greater than or equal to 20 μm and less than or equal to 140 μm, preferably greater than or equal to 30 μm and less than or equal to 130 μm, and more preferably greater than or equal to 30 μm and less than or equal to 120 μm. The basis weight of wrapping paper is not limited. The basis weight of wrapping paper is commonly greater than or equal to 20 gsm and less than or equal to 100 gsm, preferably greater than or equal to 22 gsm and less than or equal to 95 gsm, and more preferably greater than or equal to 23 gsm and less than or equal to 90 gsm. The wrapping paper may be coated or not coated. From the viewpoint of imparting a function other than strength or structural stiffness, the wrapping paper is preferably coated with a desired material.

When the filter segment 122 includes a center hole segment and a filter element, the center hole segment and the filter element may be connected by, for example, an outer plug wrapper (outer wrapping paper). The outer plug wrapper may be, for example, cylindrical paper. The tobacco rod portion 110, the cooling segment 121, and the connected center hole segment and filter element may be connected by, for example, a mouthpiece lining paper. Connection of them may be performed by, for example, applying paste, such as vinyl acetate paste, on the inner surface of the mouthpiece lining paper, putting the tobacco rod portion 110, the cooling segment 121, and the connected center hole segment and filter element in the mouthpiece lining paper, and rolling the mouthpiece lining paper. These may be connected separately with a plurality of pieces of lining paper multiple times.

The filter element of the filter segment 122 may include a breakable additive releasing container (for example, a capsule) including a breakable outer shell, such as gelatin. The mode of the capsule (which may also be referred to as “additive releasing container” in the technical field) is not limited. A known mode may be adopted. The mode of the capsule may be, for example, a breakable additive releasing container including a breakable outer shell, such as gelatin. The form of the additive releasing container is not limited. Examples of the form of the capsule include an easily breakable capsule and the shape of the capsule is preferably spherical. An additive contained in the capsule may include the above-described selected additive and particularly preferably includes a flavoring agent and activated carbon. One or more kinds of materials that help filtering smoke may be added as an additive. The form of the additive is not limited and is commonly liquid or individual. Using a capsule containing an additive is known in the technical field. An easily breakable capsule and its manufacturing method are known in the technical field.

The flavoring agent may be, for example, menthol, spearmint, peppermint, fenugreek, clove, medium-chain triglyceride (MCT), or the like. The flavoring agent may be menthol, or menthol and the like, or a combination of these materials.

The filter element of the filter segment 122 may be added with a flavoring agent. Since the filter element is added with a flavor, the delivery amount of a flavor during use increases as compared to the existing art in which a flavor is added to a tobacco filler that is a component of the tobacco rod portion 110. A degree to which the delivery amount of a flavoring agent further increases in accordance with the locations of perforations provided in the cooling segment 121. A method of adding a flavoring agent to the filter element is not limited, and a flavoring agent just has to be added so as to be uniformly dispersed in the filter element to which a flavoring agent is added. The additive amount of a flavoring agent may be a mode of adding the flavoring agent to a part with 10 vol % to 100 vol % of the filter element. The adding method may be adding a flavoring agent to the filter element in advance before the filter segment is formed or may be adding a flavoring agent after the filter segment is formed. The type of flavoring agent is not limited and may be the one similar to the flavoring agent contained in the above-described tobacco filler 111.

The filter segment 122 may include a filter element, and activated carbon may be added to at least part of the filter element. The additive amount of activated carbon to the filter element may be greater than or equal to 15.0 m²/cm² and less than or equal to 80.0 m²/cm² as a value of (Specific surface area of activated carbon)×(Weight of activated carbon)/(Sectional area of the filter element in the sectional area in a direction perpendicular to the ventilation direction) for one tobacco stick. The above “(Specific surface area of activated carbon)×(Weight of activated carbon)/(Sectional area of the filter element in the sectional area in a direction perpendicular to the ventilation direction)” may be referred to as “the surface area of activated carbon per unit sectional area” for the sake of convenience. The surface area of activated carbon per unit sectional area can be calculated in accordance with the specific surface area of activated carbon added to the filter element of one tobacco stick, the weight of activated carbon added, and the sectional area of the filter element. Activated carbon can be dispersed not uniformly in a filter element to which the activated carbon is added, and fulfillment of the above range is not required in all the section of the filter element (the section in a direction perpendicular to the ventilation direction).

The surface area of activated carbon per unit sectional area is more preferably greater than or equal to 17.0 m²/cm² and further preferably greater than or equal to 35.0 m²/cm². On the other hand, the surface area of activated carbon per unit sectional area is more preferably less than or equal to 77.0 m²/cm² and further preferably lower than or equal to 73.0 m²/cm². The surface area of activated carbon per unit sectional area can be adjusted by adjusting, for example, the specific surface area and additive amount of activated carbon and the sectional area of the filter element in a direction perpendicular to the ventilation direction. The surface area of activated carbon per unit sectional area is calculated with reference to the filter element to which activated carbon is added. When the filter segment 122 is made up of a plurality of filter elements, the sectional area and length of only the filter element to which activated carbon is added are referenced.

Examples of the activated carbon include the ones made from wood, bamboo, coconut shell, walnut shell, coal, and the like as raw materials. Activated carbon having a BET specific surface area greater than or equal to 1100 m²/g and less than or equal to 1600 m²/g may be used, preferably activated carbon having a BET specific surface area greater than or equal to 1200 m²/g and less than or equal to 1500 m²/g may be used, and more preferably activated carbon having a BET specific surface area greater than or equal to 1250 m²/g and less than or equal to 1380 m²/g may be used. A BET specific surface area can be obtained with a nitrogen gas adsorption method (BET multipoint method). Activated carbon having a pore volume greater than or equal to 400 μL/g and less than or equal to 800 μL/g may be used, more preferably activated carbon having a pore volume greater than or equal to 500 μL/g and less than or equal to 750 μL/g may be used, and more preferably activated carbon having a pore volume greater than or equal to 600 μL/g and less than or equal to 700 μL/g may be used. A pore volume can be calculated from a maximum adsorption amount obtained by using a nitrogen gas adsorption method. The additive amount of activated carbon per unit length of the filter element added with activated carbon in the ventilation direction is preferably greater than or equal to 5 mg/cm and less than or equal to 50 mg/cm, more preferably greater than or equal to 8 mg/cm and less than or equal to 40 mg/cm, and further preferably greater than or equal to 10 mg/cm and less than or equal to 35 mg/cm. When the specific surface area of activated carbon and the additive amount of activated carbon respectively fall within the above ranges, the surface area of activated carbon per unit sectional area can be adjusted to a desired one.

As activated carbon, an accumulated 10 vol % particle size (particle size D10) of activated carbon particles is preferably greater than or equal to 250 μm and less than or equal to 1200 μm. An accumulated 50 vol % particle size (particle size D50) of activated carbon particles is preferably greater than or equal to 350 μm and less than or equal to 1500 μm. The particle sizes D10 and D50 can be measured with a laser diffraction scattering method. A laser scattering particle size distribution analyzer “LA-950” made by HORIBA, Ltd. can be a device suitable for the measurement. Powder together with pure water is flowed into a cell of the analyzer, and a particle size is detected in accordance with light scattering information of particles.
Measurement conditions with the analyzer are as follows.
Measurement mode: Manual flow mode cell measurement
Dispersion medium: Ion-exchanged water
Dispersion method: Measurement after application of ultrasonic wave for a minute
Refractive index: 1.92-0.00i (sample refraction)/1.33-0.00i (dispersion medium refractive index)
Number of measurements: Twice with a different sample

A method of adding activated carbon to the filter element of the filter segment 122 is not limited. Activated carbon just needs to be added so as to be dispersed substantially uniformly in the filter element that is an object to be added with activated carbon.

The thus configured tobacco stick 100 may be coated with a lip-release material on part of the outer surface of the tipping paper 130. A lip-release material means a material configured to, when a user puts the mouthpiece portion 120 of the tobacco stick 100 in the mouth, aid contact between the lip and the tipping paper 130 to easily separate without substantial adhesion. Examples of the lip-release material may include ethyl cellulose and methyl cellulose. For example, the outer surface of the tipping paper 130 may be coated with a lip-release material by applying ethyl cellulose ink or methyl cellulose ink to the outer surface of the tipping paper 130. The lip-release material may contain nitrocellulose.

In the present embodiment, the lip-release material of the tipping paper 130 is disposed in at least a predetermined mouthpiece region that, when a user puts the mouthpiece portion 120 in the mouth, contacts with the lip of the user. More specifically, on the outer surface of the tipping paper 130, a lip-release material region R1 (see FIG. 1) coated with the lip-release material is defined as a region located between the mouthpiece end 101 of the mouthpiece portion 120 and the air holes 103.

The air-flow resistance of the thus configured tobacco stick 100 in a long-axis direction per one stick is not limited. From the viewpoint of inhalation easiness, the air-flow resistance of the tobacco stick 100 is commonly higher than or equal to 8 mmH₂O, preferably higher than or equal to 10 mmH₂O, and more preferably higher than or equal to 12 mmH₂O, and the air-flow resistance of the tobacco stick 100 is commonly lower than or equal to 100 mmH₂O, preferably lower than or equal to 80 mmH₂O, and more preferably lower than or equal to 60 mmH₂O. The air-flow resistance is measured with, for example, a filter air-flow resistance measuring device made by Cerulean in compliant with an ISO standard method (ISO6565:2015). The air-flow resistance indicates a difference in air pressure between a first end surface and a second end surface when air is flowed at a predetermined air flow rate (17.5 cc/min) from one end surface (first end surface) to the other end surface (second end surface) in a state where permeation of air does not occur at the side of the tobacco stick 100. The unit is generally mmH₂O. It is known that the relationship between the air-flow resistance and the tobacco stick 100 is a proportional relationship in an ordinarily used length range (a length of 5 mm to 200 mm). When the length of the tobacco stick 100 is doubled, the air-flow resistance is also doubled.

The rod-like tobacco stick 100 preferably has a columnar shape that satisfies a shape of which an aspect ratio defined as follows is higher than or equal to one.

Aspect Ratio=h/w

w denotes the width of the distal end 102 in the tobacco stick 100, h denotes the axial length, and it is preferable that h≥w. The cross-sectional shape of the tobacco stick 100 is not limited and may be a polygonal shape, a rounded polygonal shape, a circular shape, an elliptical shape, or the like. The width w in the tobacco stick 100 is a diameter when the cross-sectional shape of the tobacco stick 100 is a circular shape, a longitudinal diameter when the cross-sectional shape of the tobacco stick 100 is an elliptical shape, or a diameter of a circumcircle or a longitudinal diameter of a circumscribed ellipse when the cross-sectional shape of the tobacco stick 100 is a polygonal shape or a rounded polygonal shape. The axial length h of the tobacco stick 100 is not limited. The axial length h of the tobacco stick 100 is, for example, commonly greater than or equal to 40 mm, preferably greater than or equal to 45 mm, and more preferably greater than or equal to mm. The axial length h of the tobacco stick 100 is commonly less than or equal to 100 mm, preferably less than or equal to 90 mm, and more preferably less than or equal to mm. The width w of the distal end 102 of the tobacco stick 100 is not limited and is, for example, commonly greater than or equal to 5 mm and preferably greater than or equal to 5.5 mm. The width w of the distal end 102 is commonly less than or equal to 10 mm, preferably less than or equal to 9 mm, and more preferably less than or equal to 8 mm. The ratio between the length of the cooling segment 121 and the length of the filter segment 122 ((Cooling segment):(Filter segment)) in the length of the tobacco stick 100 is not limited. From the viewpoint of the delivery amount of a flavoring agent and an appropriate aerosol temperature, the ratio commonly ranges from to 1.40:0.60, preferably ranges from 0.80:1.20 to 1.20:0.80, more preferably ranges from 0.85:1.15 to 1.15:0.85, further preferably ranges from 0.90:1.10 to 1.10:0.90, and particularly preferably ranges from 0.95:1.05 to 1.05:0.95. When the ratio between the length of the cooling segment 121 and the length of the filter segment 122 falls within the above range, a balance is kept among a cooling effect, the effect of suppressing losses resulting from adhesion of generated vapor and aerosol to the inner wall of the cooling segment 121, and a function of the filter to adjust the amounts of air and a flavor, so it is possible to realize a good flavor and the strength of a flavor.

<Electric Heating Device>

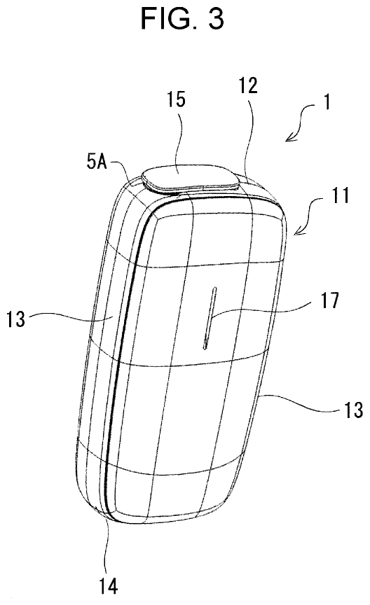

Next, the electric heating device 1 used together with the tobacco stick 100 will be described. The electric heating device 1 is an inhaler device for inhaling the tobacco stick 100 and makes up a heat-not-burn tobacco product in combination with the tobacco stick 100. FIG. 3 is an external appearance perspective view of the electric heating device 1 according to the embodiment. The electric heating device 1 includes, for example, an operation button (not shown) capable of switching between an operated state and a non-operated state when operated by a user. The electric heating device 1 heats the tobacco filler 111 of the tobacco stick 100 in the operated state without burning the tobacco filler 111 to release a flavor component from the tobacco filler 111.

The electric heating device 1 includes a housing 11 for accommodating and protecting various internal components of the device 1. In FIG. 3, reference sign 12 indicates a top panel of the housing 11, reference sign 13 indicates a bottom panel of the housing 11, and reference sign 14 indicates a side panel of the housing 11. However, in the specification, wordings related to the upper, lower, right, and left directions of the electric heating device 1 just indicate a relative positional relationship among the elements that make up the electric heating device 1. The material of the housing 11 is not limited. The housing 11 may be made of a plastic material (for example, glass-filled nylon formed by injection molding, or the like) or may be made of a metal material, such as aluminum. The shape, size, and the like of the housing 11 of the electric heating device 1 are not limited.

A slide open/close lid 15 is attached to the top panel 12 of the electric heating device 1. The open/close lid 15 is capable of opening and closing the insertion port (indicated by reference sign 5A in FIGS. 4, 6, and the like) that is open at the top panel 12 when operated to slide by a user. The insertion port of the electric heating device 1 is formed as a circular opening and is configured to allow the tobacco stick 100 to be inserted and removed. The housing 11 is provided with an indicator 17, such as an LED, that provides the operational status of the electric heating device 1 to the user.

Next, an internal structure accommodated in the housing 11 of the electric heating device 1 will be described. FIG. 4 is a view that illustrates the internal structure of the electric heating device 1 according to the embodiment. In FIG. 4, some components accommodated in the housing 11 are not shown. As shown in FIG. 4, a heater unit 20, a controller 30, a power supply 40, and the like are accommodated in the housing 11. The locations, ranges occupied in the housing, and the like, of the elements accommodated in the housing 11 are not limited and may be changed as needed.

The heater unit 20 is a unit including an electrically heating hollow tube heater 21 for heating the tobacco rod portion 110 in the tobacco stick 100 when operated. The power supply 40 is a power supply for supplying operating electric power to the hollow tube heater 21, the indicator 17, and the like and is electrically connected to the hollow tube heater 21, the indicator 17, and the like via electric wiring. The power supply 40 may be configured to include, for example, a lithium ion battery, a nickel battery, an alkaline battery, or the like. The controller 30 is a computer including a CPU, a memory, and the like and controls the operation status of the electric heating device 1 as a whole. The controller 30 may be, for example, a microcontroller in which a CPU, a memory, an input/output circuit, a timer circuit, and the like are mounted on an IC chip. The controller 30, during operation of the electric heating device 1, executes heating control to supply electric power from the power supply 40 to the hollow tube heater 21 and heat the tobacco rod portion 110 in the tobacco stick 100 with the hollow tube heater 21.

The heater unit 20 includes not only the hollow tube heater 21 having a hollow tube form defined so as to form a heating chamber inside, to which the tobacco stick 100 can be inserted, but also a heat insulator 22 that covers at least part of a section on the outer peripheral side of the hollow tube heater 21, and the like. The heat insulator 22 contributes to reducing heat produced as a result of operation of the hollow tube heater 21 and transferred to outside the electric heating device 1.

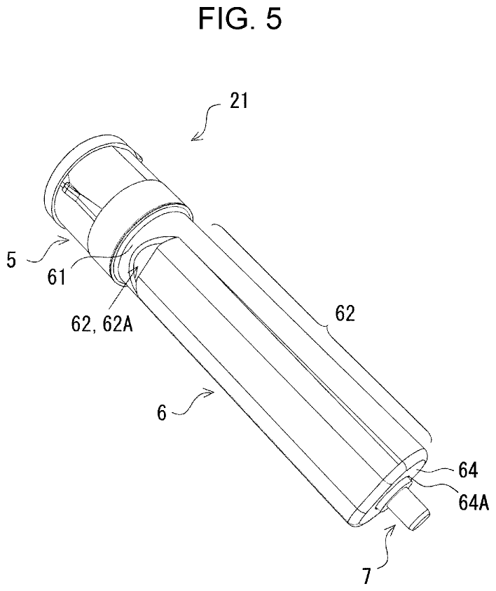

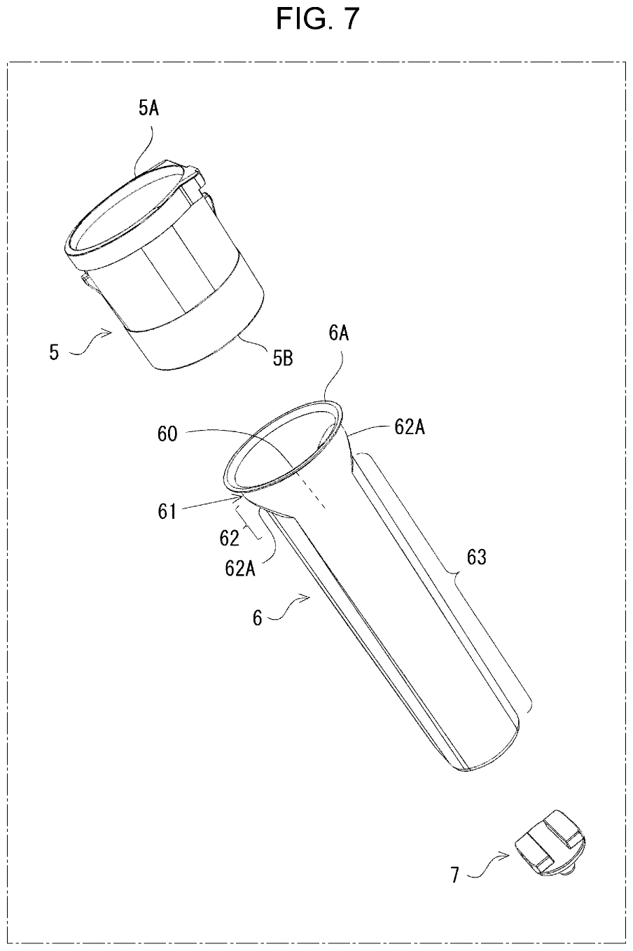

FIG. 5 is a perspective view of the hollow tube heater 21 according to the embodiment. FIG. 6 is a schematic longitudinal sectional view of the hollow tube heater 21 according to the embodiment. FIG. 7 is an exploded view of the hollow tube heater 21 according to the embodiment. As shown in FIGS. 5 to 7, the hollow tube heater 21 in the heater unit 20 is configured to include an insertion cylinder 5, a chamber tube 6, a plug member 7, and the like. Reference sign CL shown in FIG. 6 is the central axis of the hollow tube heater 21. Hereinafter, description will be made on the assumption that a section taken along the central axis CL of the hollow tube heater 21 is referred to as “longitudinal section” and a section taken in a direction perpendicular to the central axis CL is referred to as “cross section”.

The insertion cylinder 5 of the hollow tube heater 21 is a sleeve member having a hollow cylindrical shape. An opening end formed at the upper end of the insertion cylinder 5 is formed as the insertion port 5A. The insertion port 5A is an opening for inserting the tobacco stick 100 into the hollow tube heater 21 (into the heating chamber) so as to be removable.

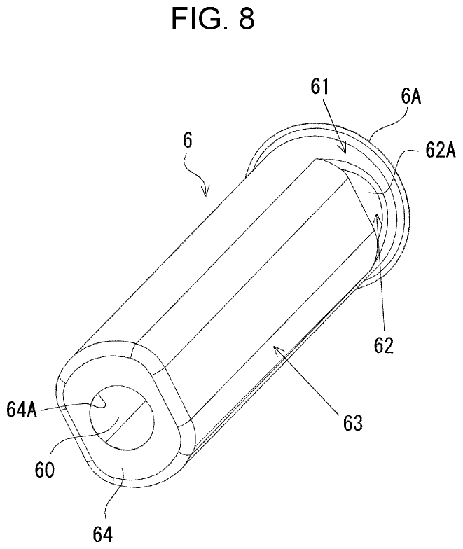

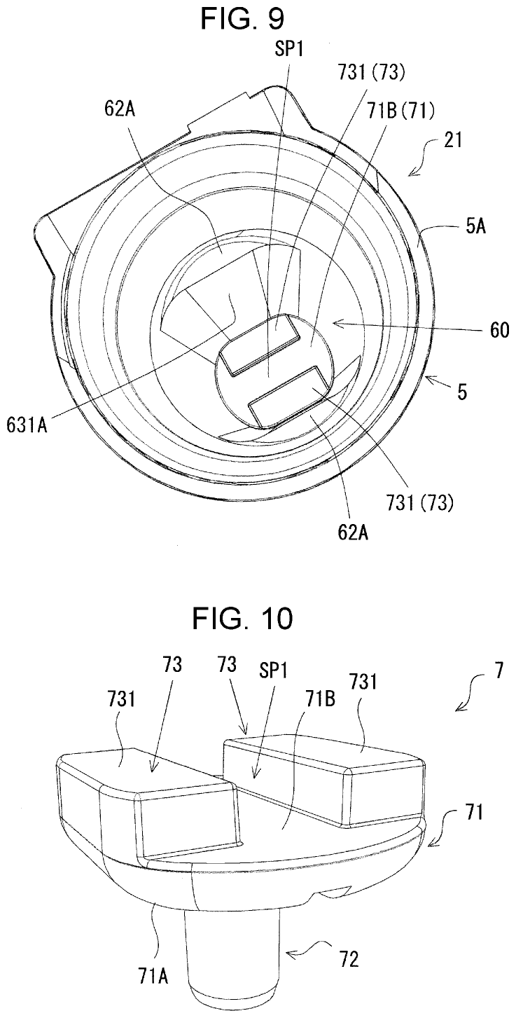

FIG. 8 is a perspective view of the chamber tube 6 according to the embodiment. The chamber tube 6 is a closed end hollow cylindrical member of which an upper end 6A is formed as an opening end, and a hollow heating chamber 60 is formed inside. FIG. 9 is a view of the heating chamber 60 in the hollow tube heater 21 according to the embodiment when seen from the insertion port 5A side.

The upper end 6A of the chamber tube 6 is coupled to a lower end 5B of the insertion cylinder 5. Thus, the insertion cylinder 5 and the chamber tube 6 are configured as one unit. A bottom wall 64 is formed at the lower end of the chamber tube 6. An opening 64A is formed at the plane center of the bottom wall 64.

The chamber tube 6 is configured to include a connection cylinder 61 located adjacent to the upper end 6A, a narrowed cylinder 62 located below the connection cylinder 61, and a compression cylinder 63 located below the narrowed cylinder 62. An annular flange extending radially outward of the connection cylinder 61 is provided at the upper end 6A of the connection cylinder 61. The annular flange is coupled to an end surface at the lower end 5B of the insertion cylinder 5. The connection cylinder 61 of the chamber tube 6 has a substantially hollow cylindrical shape. For example, the inside diameter of the connection cylinder 61 is equal to the inside diameter of the lower end 5B at the insertion cylinder 5.

As shown in FIG. 8 or the like, the compression cylinder 63 of the chamber tube 6 is formed as a hollow cylinder of which the cross section has a substantially oblong shape (elliptical shape). In the narrowed cylinder 62 of the chamber tube 6, the upper end connected to the connection cylinder 61 has a hollow cylindrical shape, and the lower end connected to the compression cylinder 63 has a substantially oblong (elliptical) cylinder shape. As described above, the narrowed cylinder 62 of the chamber tube 6 according to the present embodiment has a form such that the sectional shape gradually changes along the axial direction of the narrowed cylinder 62. More specifically, the narrowed cylinder 62 of the chamber tube 6 has a pair of narrowed walls 62A gradually tapered toward the lower end of the narrowed cylinder 62 at locations opposite across the central axis of the chamber tube 6. The cross-sectional shape of the narrowed cylinder 62 is continuously changed along the axial direction by the pair of narrowed walls 62A.

Next, the plug member 7 of the hollow tube heater 21 will be described. As shown in FIGS. 5 and 6, the plug member 7 is a member to be attached to the bottom wall 64 of the chamber tube 6 (compression cylinder 63). FIG. 10 is a perspective view of the plug member 7 according to the embodiment. The plug member 7 is configured to include a main body 71 located adjacent to the heating chamber 60 along the inner surface of the bottom wall 64 when the plug member 7 is attached to the bottom wall 64 of the chamber tube 6 (compression cylinder 63), a protrusion 72 protruding from a lower surface 71A of the main body 71, and a set of bases 73 projecting upward from an upper surface 71B side of the main body 71. The main body 71 has a size such that the main body 71 can be attached to the inside of the compression cylinder 63. The protrusion 72 of the plug member 7 has a stepped cylindrical columnar form. The diameter of a proximal end 721 of the protrusion 72 is slightly smaller than the opening 64A of the bottom wall 64 and is configured to be insertable through the opening 64A. In a state where the plug member 7 is attached to the bottom wall 64 of the compression cylinder 63, the protrusion 72 protrudes outward of the heating chamber 60 through the opening 64A of the bottom wall 64.

The set of bases 73 of the plug member 7 is disposed with a space in the cross-sectional direction of the heating chamber 60, and a space SP1 is formed therebetween. The upper surface of each base 73 is formed as a positioning bottom surface 731 that, when the tobacco stick 100 is inserted through the insertion port 5A into the hollow tube heater 21 (into the heating chamber 60), contacts with the distal end 102 of the tobacco rod portion 110 to position the tobacco rod portion 110. The positioning bottom surfaces 731 of the bases 73 are flat and are located at the same level in the heating chamber 60. The tobacco stick 100 inserted in the heating chamber 60 is designed to be inserted to a prescribed location at the time when the distal end 102 of the tobacco rod portion 110 contacts with the positioning bottom surfaces 731 of the bases 73. In other words, in the hollow tube heater 21, the location (prescribed location) of the positioning bottom surface 731 of each base 73 corresponds to a deepest location of the heating chamber 60. In a state where the tobacco stick 100 is inserted to the deepest location of the heating chamber 60, the distal end 102 of the tobacco rod portion 110 is placed astride above the space SP1 formed between the set of bases 73. When the tobacco stick 10 is inhaled by using the electric heating device 1, air flowing through the insertion port 5A into the heating chamber 60 of the hollow tube heater 21 is introduced through the spaced between the inner wall surface of the hollow tube heater 21 and the tobacco stick 10 to the bottom side of the heating chamber 60 and then through the space SP1 from the distal end 102 of the tobacco rod portion 110 to the inside of the tobacco rod portion 110.

As shown in FIG. 6, the chamber tube 6 according to the present embodiment has a heater region RH in at least part of the compression cylinder 63. The heater region RH of the compression cylinder 63 is a heating region for heating at least the tobacco rod portion 110 from the outer peripheral side, of the tobacco stick 100 inserted in the heating chamber 60, and includes a heater element 23 that produces heat when energized. The heater element 23 is not shown as needed in the drawings other than FIG. 6. The heater element 23 provided in the heater region RH is an element that produces heat when operating electric power is supplied from the power supply 40 and is not limited. The heater region RH of the compression cylinder 63 is, for example, a metal tube made of a stainless steel, or the like, and a metal thin film heater may be disposed on the outer periphery of the metal tube. The metal thin film heater is a sheet heating heater that uses a metal thin film for a heat generator and that has flexibility. Instead of the metal thin film heater, a film heater may be disposed in the heater region RH of the compression cylinder 63 along the outer periphery of the metal tube. The film heater can have, for example, a structure in which a layer made of an electrical insulating material and a layer made of a heating truck that is an example of a heating element are laminated. For example, a structure in which a layer made up of a heating truck between the heater element 23 and the layer made of two-layer electrical insulating materials can be provided. The electrical insulating material can be, for example, polyimide, and the heating truck can be, for example, a metal, such as stainless steel. The heater region RH of the compression cylinder 63 may contain a ceramics material. Examples of the ceramics material include alumina, aluminum nitride, and silicon nitride ceramics, and these materials may be laminated and sintered.

When the controller 30 of the electric heating device 1 executes heating control over the hollow tube heater 21, the heater element installed in the heating wall RH of the hollow tube heater 21 is energized when supplied with electric power from the power supply 40. Then, the heating wall RH produces heat, with the result that the tobacco rod portion 110 of the tobacco stick 100 inserted in the heating chamber 60 can be heated from the outer peripheral side.

In the present embodiment, since the heater element 23 is disposed over substantially the entire section of the compression cylinder 63 of the hollow tube heater 21 in the axial direction, the heating wall RH is formed over the section. In the example shown in FIG. 6, since the heater element 23 is installed so as to cover the outer periphery of the compression cylinder 63 from the upper end of the compression cylinder 63 in the axial direction to a location corresponding to the level of the positioning bottom surfaces 731 of the bases 73, the heating wall RH is formed in the region. However, the installation mode of the heater element 23 provided in the compression cylinder 63 is not limited. In other words, the heating wall RH may be formed over the entire section of the compression cylinder 63 or may be formed only in a section further shorter than the range shown in FIG. 6. The heater element 23 in the compression cylinder 63 may be provided on the outer peripheral side of the compression cylinder 63. For example, the heater element 23 may be buried in the wall of the compression cylinder 63 or may be disposed on an inner peripheral side.

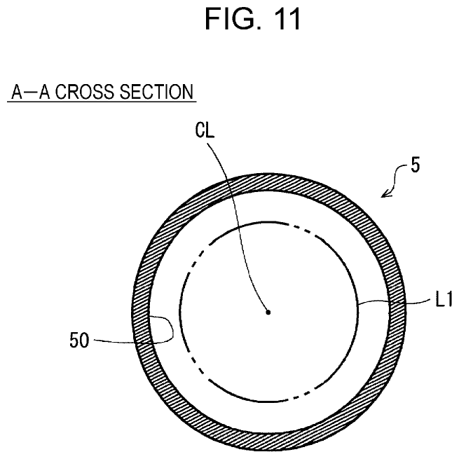

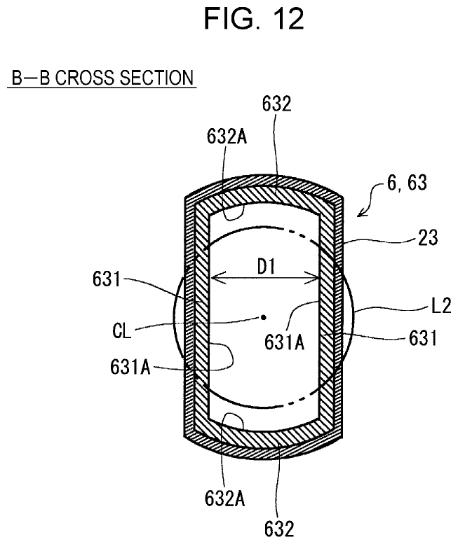

Here, FIG. 11 is a cross-sectional view of the hollow tube heater 21, taken along the line A-A in FIG. 6 (A-A cross section). FIG. 12 is a cross-sectional view of the hollow tube heater 21, taken along the line B-B in FIG. 6 (B-B cross section). The A-A cross section of the hollow tube heater 21 corresponds to the cross section of the insertion cylinder 5, and the B-B cross section corresponds to the cross section of the compression cylinder 63 in the chamber tube 6.

The compression cylinder 63 of the hollow tube heater 21 is configured to, when the tobacco stick 100 is inserted into the heating chamber 60, compress at least the tobacco rod portion 110 from the outer peripheral side. Hereinafter, when the diameter of the tobacco stick 100 (the tobacco rod portion 110, the mouthpiece portion 120) is simply referred to, it is intended to refer to the diameter in an original form (before being compressed by the compression cylinder 63), and, when it is intended to refer to the diameter of the tobacco stick 100 (the tobacco rod portion 110, the mouthpiece portion 120) after being compressed by the compression cylinder 63, the intention is specified.

The insertion cylinder 5 of the hollow tube heater 21 has a relatively greater inner cross-sectional area than the cross-sectional area of the tobacco stick 100 (the tobacco rod portion 110, the mouthpiece portion 120). More specifically, the inside diameter of the insertion cylinder 5 is relatively greater than the diameter of the tobacco stick 100 (the tobacco rod portion 110, the mouthpiece portion 120). Reference sign L1 shown in the A-A cross section of FIG. 6 indicates the outer shape (outline) of the tobacco stick 100 in the cross-sectional direction in a state of being inserted in the insertion cylinder 5 of the hollow tube heater 21. As shown in the drawing, a space is formed between the inner wall surface 50 of the insertion cylinder 5 and the outline L1 of the tobacco stick 100. With this configuration, when the user inserts the tobacco stick 100 through the insertion port 5A, the user is able to smoothly insert the tobacco stick 100 into the heating chamber 60. In a state where the tobacco stick 100 is inserted in the heating chamber 60, the space between the inner wall surface 50 of the insertion cylinder 5 and the tobacco stick 100 can be formed as an airflow path.

On the other hand, the compression cylinder 63 of the hollow tube heater 21 has substantially a cylindrical (elliptic cylindrical) shape as described above. Therefore, as shown in the B-B inner cross-sectional view of FIG. 6, the inner cross section of the compression cylinder 63 is formed as a substantially oblong shape (elliptical shape). The compression cylinder 63 is made up of a pair of opposite sandwiching walls 631 and a pair of circular arc walls 632 connecting the ends of the sandwiching walls 631. The sandwiching walls 631 and the circular arc walls 632 extend along the axial direction of the compression cylinder 63. Here, inner wall surfaces 631A of the pair of sandwiching walls 631 extend along the axial direction of the compression cylinder 63 and are opposed parallel to each other. Inner wall surfaces 632A of the pair of circular arc walls 632 also extend along the axial direction of the compression cylinder 63 and are opposed parallel to each other.

A distance between the inner wall surfaces 631A of the pair of sandwiching walls 631 is referred to as “sandwiching wall-to-sandwiching wall distance D1”. The sandwiching wall-to-sandwiching wall distance D1 is set to a dimension less than the diameter of the tobacco stick 100 (the tobacco rod portion 110, the mouthpiece portion 120). In the B-B inner cross-sectional view of FIG. 6, reference sign L2 indicates the outer shape (outline) of the tobacco stick 100 in the cross-sectional direction in an original form. In the present embodiment, the cross-sectional area of the tobacco stick 100 (the tobacco rod portion 110, the mouthpiece portion 120) is relatively greater than the inner cross-sectional area of the compression cylinder 63 and is defined such that the tobacco stick 100 (the tobacco rod portion 110, the mouthpiece portion 120) inserted in the compression cylinder 63 is compressed by the inner wall surface of the compression cylinder 63. More specifically, the sandwiching wall-to-sandwiching wall distance D1 between the pair of opposite sandwiching walls 631 of the compression cylinder 63 is set to a dimension less than the diameter of the tobacco stick 100 (the tobacco rod portion 110, the mouthpiece portion 120). Therefore, when the tobacco stick 100 is inserted in the compression cylinder 63 of the hollow tube heater 21, the tobacco stick 100 receives compression from the outer peripheral side by being sandwiched by the inner wall surfaces 631A of the pair of sandwiching walls 631. In the present embodiment, when the tobacco stick 100 is inserted in the compression cylinder 63 of the hollow tube heater 21, spaces are designed to be formed between the inner wall surfaces 632A of the pair of circular arc walls 632 and the peripheral surface of the tobacco stick 100. Alternatively, the inner wall surfaces 632A may be designed to contact with the peripheral surface of the tobacco stick 100.

The sandwiching wall-to-sandwiching wall distance D1 of the compression cylinder 63 is substantially equal to the short-axis dimension of the inner cross section of the compression cylinder 63 having a substantially oblong (elliptical) shape. The long-axis dimension of the inner cross section of the compression cylinder 63 is not limited. In an example, in the present embodiment, the long-axis dimension of the inner cross section of the compression cylinder 63 is equal to the diameter of the tobacco stick 100 (the tobacco rod portion 110, the mouthpiece portion 120). However, the long-axis dimension of the inner cross section of the compression cylinder 63 may be set to a dimension less than the diameter of the tobacco stick 100 (the tobacco rod portion 110, the mouthpiece portion 120) or may be set to a dimension greater than the diameter of the tobacco stick 100 (the tobacco rod portion 110, the mouthpiece portion 120).

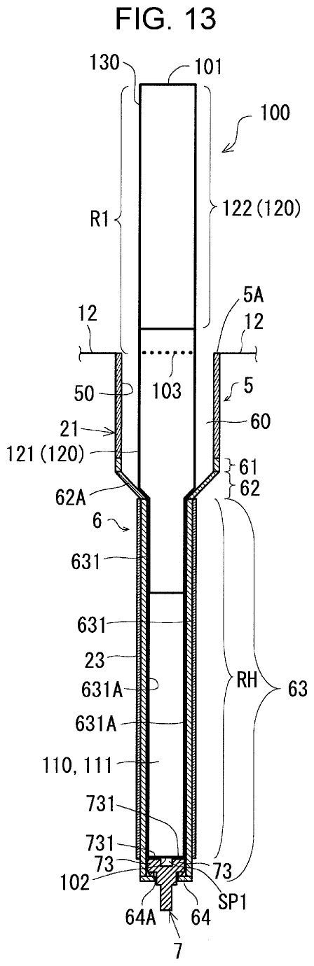

FIG. 13 is a view that illustrates a state where the tobacco stick 100 is inserted to a prescribed location in the heating chamber 60 of the electric heating device 1 according to the embodiment. As shown in FIG. 13, the tobacco stick 100 inserted to the prescribed location of the heating chamber 60 is positioned in a state where the distal end 102 of the tobacco rod portion 110 contacts with the positioning bottom surfaces 731 of the bases 73 in the hollow tube heater 21, that is, the bottom surface of the heating chamber 60. As shown in FIG. 13, in a state where the tobacco stick 100 is inserted to the prescribed location (positioning bottom surfaces 731) of the heating chamber 60, the location (level) of the air holes 103 in the mouthpiece portion 120 (cooling segment 121) coincides with the location (level) of the insertion port 5A.

The axial length of the compression cylinder 63 from the upper end of the compression cylinder 63 in the hollow tube heater 21 to the positioning bottom surfaces 731 of the bases 73 is greater than the length of the tobacco rod portion 110. Therefore, in the tobacco stick 100 inserted to the prescribed location of the heating chamber 60 in the hollow tube heater 21, the whole of the tobacco rod portion 110 and part of the mouthpiece portion 120 are inserted in the compression cylinder 63. Thus, the whole of the tobacco rod portion 110 and part of the mouthpiece portion 120 are sandwiched between the inner wall surfaces 631A of the pair of sandwiching walls 631, and these are compressed from the outer peripheral side.

Then, when the operation button of the electric heating device 1 is turned on by the user in a predetermined manner, the controller 30 starts heating control to start supplying electric power from the power supply 40 to the hollow tube heater 21 to heat the tobacco rod portion 110 of the tobacco stick 100. When heating control is started, the heater element 23 installed at the heating wall RH of the compression cylinder 63 in the hollow tube heater 21 is energized, so the heating wall RH produces heat. Thus, it is possible to heat the tobacco filler 111 contained in the tobacco rod portion 110 of the tobacco stick 100 without burning the tobacco filler 111 and generate vapor containing an aerosol-source material and a tobacco flavor component.

In the compression cylinder 63 of the hollow tube heater 21 according to the present embodiment, the entire region in the axial direction is formed as the heating wall RH. Therefore, during operation of the hollow tube heater 21, the tobacco rod portion 110 can be heated in a state where the tobacco rod portion 110 is compressed by the compression cylinder 63 (heating wall RH). In this way, when the tobacco rod portion 110 is compressed and heated from the outer peripheral side, it is possible to efficiently transfer heat of the heating wall RH (heater element 23) to the tobacco filler 111 of the tobacco rod portion 110. As a result, the tobacco filler 111 of the tobacco rod portion 110 is efficiently heated, with the result that it is possible to increase the delivery amount of an aerosol and a flavor component.

In addition, the tobacco rod portion 110 in the tobacco stick 100 is wrapped with the rolling paper 112 in a state where the tobacco filler 111 contains shredded tobacco in a random alignment. Therefore, shredded tobacco is disposed in a uniformly dispersed state in the cross section of the tobacco rod portion 110, and gaps between shredded pieces of tobacco are reduced. As a result, even when the tobacco rod portion 110 is compressed from the outer peripheral side as a result of insertion into the compression cylinder 63, it is possible to suppress a significant change in air-flow resistance during inhalation. In other words, variations in air-flow resistance during inhalation among tobacco sticks 100 are less likely to occur, so it is possible to contribute to ensuring stable quality of flavor and smoke taste of the tobacco stick 100. In other words, with the tobacco stick 100 and a heat-not-burn tobacco product including the tobacco stick 100 according to the present embodiment, it is possible to ensure the delivery amount of a flavor component of the tobacco stick 100 and suppress variations in air-flow resistance.

In the cross-sectional area of the tobacco rod portion 110 according to the present embodiment, the cross-sectional area after being inserted into the compression cylinder 63 of the electric heating device 1 is preferably defined so as to be greater than or equal to 60% and less than or equal to 99% of the cross-sectional area before insertion and more preferably defined so as to be greater than or equal to 80% and less than or equal to 98%. The diameter of the tobacco rod portion 110 is preferably defined to a dimension greater than or equal to 105% and less than or equal to 200% of the space between the inner wall surfaces 631A of the pair of sandwiching walls 631 and more preferably defined to a dimension greater than or equal to 109% and less than or equal to 140%. With these configurations, during operation of the hollow tube heater 21 in the electric heating device 1, it is possible to further efficiently transfer heat of the heating wall RH (heater element 23) to the tobacco filler 111 of the tobacco rod portion 110 and further efficiently heat the tobacco filler 111. When the cross-sectional area of the tobacco rod portion 110 after being inserted into the compression cylinder 63 of the electric heating device 1 is less than 60% of the cross-sectional area before insertion, the tobacco rod portion 110 may be excessively compressed at the time of being inserted into the compression cylinder 63. As a result, the rolling paper 112 may be ripped at the time of insertion into the compression cylinder 63 or may be hard to be inhaled because of an excessive increase in the air-flow resistance of the tobacco rod portion 110.

Vapor containing an aerosol-source material and a tobacco flavor component, generated in the tobacco rod portion 110 during operation of the hollow tube heater 21, flows from the tobacco rod portion 110 into the mouthpiece portion 120 and the cooling segment 121, and contacts with air taken through the air holes 103 into the cavity of the cooling segment 121 to be cooled. In this way, it is possible to decrease the temperature of components and air flowing from the tobacco rod portion 110. Then, the vapor of the aerosol-source material is cooled in the cooling segment 121 to liquefy, and generation of an aerosol is facilitated. Then, an aerosol containing a flavor component passes through the filter segment 122 and is inhaled into the oral cavity from the mouthpiece end 101.

As described above, in a state where the tobacco stick 100 is inserted to the prescribed location of the heating chamber 60, the whole of the tobacco rod portion 110 and part of the mouthpiece portion 120 (cooling segment 121) are configured to be compressed by the inner wall surface of the compression cylinder 63 (the inner wall surfaces 631A of the pair of sandwiching walls 631). During operation of the hollow tube heater 21, not only the tobacco rod portion 110 of the tobacco stick 100 but also the mouthpiece portion 120 (cooling segment 121) is heated in a state of being compressed by the inner wall surface of the compression cylinder 63, so the effect that vapor and an aerosol are hard to adhere to the inner wall of the mouthpiece portion 120 (cooling segment 121) is obtained. The cross-sectional area of the mouthpiece portion 120 after being inserted into the compression cylinder 63 is preferably defined so as to be greater than or equal to 60% and less than or equal to 99% of the cross-sectional area before insertion and more preferably defined so as to be greater than or equal to 80% and less than or equal to 98%. Thus, it is possible to further remarkably obtain the above-described effect of suppressing adhesion of vapor and an aerosol. When the cross-sectional area of the mouthpiece portion 120 after being inserted into the compression cylinder 63 of the electric heating device 1 is less than 60% of the cross-sectional area before insertion, the mouthpiece portion 120 may be excessively compressed at the time of being inserted into the compression cylinder 63. As a result, the mouthpiece portion 120 may break at the time of insertion into the compression cylinder 63. On the other hand, when the cross-sectional area of the mouthpiece portion 120 after being inserted into the compression cylinder 63 is greater than 99% of the cross-sectional area before insertion, adhesion between the mouthpiece portion 120 and the hollow tube heater 21 decreases, so the effect that vapor and an aerosol are hard to adhere to the inner wall of the mouthpiece portion 120 is not sufficiently obtained.

When the tobacco stick 100 is inserted into the heating chamber 60 of the hollow tube heater 21 in the electric heating device 1, the tobacco stick 100 is inserted to the prescribed location (positioning bottom surfaces 731) of the heating chamber 60 while receiving resistance due to contact with the pair of sandwiching walls 631 of the compression cylinder 63. In other words, in the present embodiment, since insertion resistance occurs due to contact with the sandwiching walls 631 before the distal end 102 of the tobacco stick 100 contacts with the positioning bottom surfaces 731 of the heating chamber 60, it is difficult for the user to find the instance at which the distal end 102 of the tobacco stick 100 contacts with the positioning bottom surfaces 731 of the heating chamber 60 from a change in insertion resistance of the tobacco stick 100.

In contrast, the tobacco stick 100 is defined such that, in a state where the distal end 102 of the tobacco rod portion 110 is inserted to the prescribed location (positioning bottom surfaces 731) of the heating chamber 60, the location (level) of the air holes 103 provided in the mouthpiece portion 120 (cooling segment 121) coincide with the location (level) of the insertion port 5A of the heating chamber 60. Thus, the user is able to easily visually find the timing to stop insertion operation in accordance with a relative position between the location (level) of the air holes 103 and the location (level) of the insertion port 5A at the time of inserting the tobacco stick 100 into the heating chamber 60. In other words, at the time of inserting the tobacco stick 100 into the heating chamber 60, the location of the air holes 103 is used as a mark, and, at the time when it is visually confirmed that the location (level) of the air holes 103 coincides with the location (level) of the insertion port 5A, the instance at which the distal end 102 of the tobacco stick 100 contacts with the positioning bottom surfaces 731 of the heating chamber 60 can be found not depending on a change in the insertion resistance of the tobacco stick 100.

Thus, when the tobacco stick 100 is inserted into the hollow tube heater 21 of the electric heating device 1, it is possible to accurately insert the tobacco stick 100 to the prescribed location only by inserting the tobacco stick 100 until the location of the air holes 103 in the tobacco stick 100 coincides with the level of the insertion port 5A. Then, it is possible to appropriately find the timing at which the tobacco stick 100 is inserted to the prescribed location. Therefore, an action to, although the distal end 102 of the tobacco stick 100 contacts with the positioning bottom surfaces 731 of the heating chamber 60, further push the tobacco stick 100 into the heating chamber 60 from that state can be suppressed beforehand. Thus, it is possible to reduce buckling of the tobacco stick 100 halfway or collapsing of the tobacco stick 100 in the axial direction. When the tobacco stick 100 is inserted into the heating chamber 60 of the hollow tube heater 21, it is possible to reduce a situation in which the user mistakes insertion resistance resulting from contact of the tobacco stick 100 with the sandwiching walls 631 as contact of the distal end 102 of the tobacco stick 100 with the positioning bottom surfaces 731 of the heating chamber 60 and, as a result, stop insertion operation of the tobacco stick 100 before the prescribed location.

When the air holes 103 that introduce outside air into the cooling segment 121 of the mouthpiece portion 120 is located on the upstream side of the cooling segment 121 (the tobacco rod portion 110 side), the effect of cooling vapor or the like of a volatile component released from the tobacco filler 111 heated during inhalation of the tobacco stick 100 is relatively large. On the other hand, when the air holes 103 are located in the heating chamber 60 (a region below the insertion port 5A and surrounded by the wall surface of the hollow tube heater 21) during inhalation of the tobacco stick 100, it is hard to smoothly introduce outside air into the mouthpiece portion 120 (cooling segment 121) through the air holes 103 during inhalation. In contrast, since the tobacco stick 100 according to the present embodiment is configured such that, in a state where insertion of the tobacco stick 100 to the prescribed location (positioning bottom surfaces 731) of the heating chamber 60 is complete, the location (level) of the air holes 103 of the mouthpiece portion 120 (cooling segment 121) coincides with the location (level) of the insertion port 5A of the heating chamber 60, both the cooling effect of the cooling segment 121 during inhalation and the effect of taking in outside air through the air holes 103 are achieved. In other words, from the viewpoint of achieving both the cooling effect of the cooling segment 121 during inhalation and the effect of taking in outside air through the air holes 103, the location of the air holes 103 in the tobacco stick 100 and the insertion depth of the heating chamber 60 can be defined to an optimal relative relationship.

The tobacco stick 100 according to the present embodiment is coated with a lip-release material on the outer surface of the tipping paper 130 in a lip-release material region R1 (see FIGS. 1, 13, and the like) located between the mouthpiece end 101 of the mouthpiece portion 120 and the air holes 103. In the present embodiment, the lip-release material region R1 where a lip-release material is disposed is defined as a region located at least adjacent to the insertion port 5A with respect to the heating wall RH of the compression cylinder 63 when the distal end 102 of the tobacco rod portion 110 (tobacco stick 100) is inserted to the prescribed location (the positioning bottom surfaces 731, the deepest location) of the heating chamber 60. With this configuration, when the heating wall RH of the compression cylinder 63 produces heat as a result of operation of the hollow tube heater 21 of the electric heating device 1, direct heating of the lip-release material in the lip-release material region R1 in the tobacco stick 100 with the heating wall RH can be suppressed. As a result, it is possible to reduce release of a component that can influence the flavor and smoke taste of the tobacco stick 100 from the lip-release material. In the present embodiment, particularly, the lip-release material region R1 is defined as a region located between the mouthpiece end 101 of the mouthpiece portion 120 and the air holes 103. As described above, the air holes 103 of the mouthpiece portion 120 is defined so as to, when the distal end 102 of the tobacco stick 100 is inserted to the prescribed location (the positioning bottom surfaces 731, the deepest location) of the heating chamber 60, coincide with the location (level) of the insertion port 5A of the heating chamber 60. Therefore, by setting the range of the lip-release material region R1 in the tobacco stick 100 as described above, when the tobacco stick 100 is inserted to the deepest location of the heating chamber 60, it is possible to reliably position the lip-release material region R1 adjacent to the insertion port 5A as compared to the heating wall RH of the compression cylinder 63.

Here, an example of a technique to quantify the coating amount of the lip-release material on the tipping paper will be described. Appliances used in the quantification method are a rotary evaporator, a constant-temperature water bath, a cooling tube, and an absorbance measuring device. Initially, a sample obtained by shredding tipping paper coated with a lip-release material is prepared, and the sample is put in an Erlenmeyer flask weighed in advance to weigh the sample weight (step 1). Subsequently, 100 ml of acetone is added into the Erlenmeyer flask as a reagent, and then ultrasonic extraction is performed for 30 minutes (step 2). Subsequently, an extract extracted in step 2 is transferred to a 300 ml eggplant flask, and acetone in the extract is volatilized with the rotary evaporator (step 3). In step 3, volatilization of acetone is performed in a state where the eggplant flask is set such that the eggplant flask is soaked in the constant-temperature water bath set to a water temperature of 40° C. Subsequently, 25 ml of acetone is put in the eggplant flask in several batches, and nonvolatile matter remaining in the flask is dissolved again (step 4). Subsequently, 50 ml of the solution obtained by dissolving nonvolatile matter again in step 4 is transferred to another eggplant flask, and then acetone in the solution is volatilized with the evaporator (step 5). Subsequently, 10 ml of acetone and 10 ml of 10% KOH are added into the eggplant flask in which the solution from which acetone was volatilized in step 5 is put, the cooling tube is set to the eggplant flask, and then reflux is performed for an hour in the constant-temperature water bath with a water temperature of 60° C. (step 6). Subsequently, the solution is cooled to a room temperature on ice, and then filtered with filter paper (step 7). Filtering in step 7 uses the one obtained by putting 50 ml of filtrate in a volumetric flask and filling up to the line of the volumetric flask with a mixed solution of acetone and water (acetone:water=2:1). Subsequently, the absorbance of the solution filtered in step 7 is measured with the absorbance measuring device.

The embodiment according to the present invention has been described above; however, components, combinations thereof, and the like in the embodiment are one example, and additions, omissions, replacements, and other changes are possible as needed without departing from the purport of the present invention. For example, a specific mode of the compression cylinder 63 in the hollow tube heater 21 of the electric heating device 1 is not limited as long as the cross-sectional area of the compression cylinder 63 is relatively less than the cross-sectional area of the tobacco stick 100. Therefore, in the above embodiment, the mode in which the compression cylinder 63 is configured to include the pair of sandwiching walls 631 opposed parallel to each other along the axial direction has been described as an example. Alternatively, a mode in which the tobacco stick 100 inserted in the compression cylinder 63 is compressed from the outer peripheral side by sandwiching the tobacco stick 100 between non-parallel walls may be adopted.

The compression cylinder 63 of the hollow tube heater 21 may be a cylindrical body having an inside diameter less than the diameter of the tobacco stick 100. In this case, the narrowed cylinder 62 located between the connection cylinder 61 and the compression cylinder 63 in the chamber tube 6 may be configured such that the inside diameter gradually reduces in a tapered manner from the upper end side connected to the connection cylinder 61 toward the lower end side connected to the compression cylinder 63. In any of the above modes, it is possible to compress the tobacco stick 100 from the outer peripheral side with the inner wall surface of the compression cylinder 63, so compression and heating of the tobacco stick 100 are possible during operation of the hollow tube heater 21.

### REFERENCE SIGNS LIST

1 electric heating device
5 insertion cylinder
6 chamber tube
11 housing
20 heater unit
21 hollow tube heater
5A insertion port
60 heating chamber
61 connection cylinder
62 narrowed cylinder
63 compression cylinder
RH heating wall
100 tobacco stick
103 air hole
110 tobacco rod portion
120 mouthpiece portion
121 cooling segment
122 filter segment
130 tipping paper
631 sandwiching wall

1. A heat-not-burn tobacco product comprising: an electric heating device; and a heat-not-burn tobacco stick used together with the electric heating device, wherein
the heat-not-burn tobacco stick includes
a tobacco rod portion that includes a tobacco filler including shredded tobacco and rolling paper wrapping the tobacco filler,
a mouthpiece portion coaxially coupled to the tobacco rod portion when wrapped with tipping paper together with the tobacco rod portion, and
an air hole provided in the mouthpiece portion,
the electric heating device includes a hollow tube heater defined so as to form a heating chamber inside, the heating chamber allowing the heat-not-burn tobacco stick to be inserted,
the hollow tube heater includes
a compression cylinder used to compress the tobacco rod portion from an outer peripheral side when the heat-not-burn tobacco stick is inserted, and
a heating wall formed from at least part of the compression cylinder and used to heat the tobacco rod portion from the outer peripheral side,
a cross-sectional area of the tobacco rod portion is relatively greater than an inner cross-sectional area of the compression cylinder and defined such that the tobacco rod portion inserted in the compression cylinder is compressed by an inner wall surface of the compression cylinder,
a location of the air hole provided in the mouthpiece portion is defined so as to coincide with a location of an insertion port of the heating chamber when a distal end of the tobacco rod portion is inserted to a prescribed location of the heating chamber,
part of an outer surface of the tipping paper is coated with a lip-release material, and
of the outer surface of the tipping paper, a lip-release material region coated with the lip-release material is defined as a region located adjacent to the insertion port with respect to at least the heating wall when a distal end of the tobacco rod portion is inserted to the prescribed location of the heating chamber.

2. The heat-not-burn tobacco product according to claim 1, wherein the prescribed location is a deepest location of the heating chamber.

3. The heat-not-burn tobacco product according to claim 1, wherein the lip-release material region is a region located between the air hole and a mouthpiece end of the mouthpiece portion.

4. The heat-not-burn tobacco product according to claim 1, wherein the cross-sectional area of the tobacco rod portion is defined such that the cross-sectional area after insertion into the compression cylinder is greater than or equal to 60% and less than or equal to 99% of the cross-sectional area before insertion into the compression cylinder.

5. The heat-not-burn tobacco product according to claim 1, wherein the compression cylinder includes a pair of opposite sandwiching walls extending along an axial direction of the compression cylinder, and the tobacco rod portion inserted in the compression cylinder is compressed by inner wall surfaces of the sandwiching walls.

6. The heat-not-burn tobacco product according to claim 5, wherein the inner wall surfaces of the pair of sandwiching walls are opposed parallel to each other.

7. The heat-not-burn tobacco product according to claim 6, wherein a diameter of the tobacco rod portion is defined to a dimension greater than or equal to 105% and less than or equal to 200% of a space between the inner wall surfaces of the pair of sandwiching walls.

8. The heat-not-burn tobacco product according to claim 1, wherein, in a state where the heat-not-burn tobacco stick is inserted to a prescribed location of the heating chamber, a whole of the tobacco rod portion and part of the mouthpiece portion are compressed by the inner wall surface of the compression cylinder.

9. The heat-not-burn tobacco product according to claim 8, wherein a cross-sectional area of the mouthpiece portion is defined such that the cross-sectional area after insertion into the compression cylinder is greater than or equal to 60% and less than or equal to 99% of the cross-sectional area before insertion into the compression cylinder.

10. A heat-not-burn tobacco stick used together with an electric heating device and heated from an outer peripheral side in a state of being inserted in a hollow tube heater defined such that a heating chamber of the electric heating device is formed inside, the heat-not-burn tobacco stick comprising:
a tobacco rod portion that includes a tobacco filler including shredded tobacco and rolling paper wrapping the tobacco filler;
a mouthpiece portion coaxially coupled to the tobacco rod portion when wrapped with tipping paper together with the tobacco rod portion; and
an air hole provided in the mouthpiece portion,
a cross-sectional area of the tobacco rod portion is relatively greater than an inner cross-sectional area of a compression cylinder of the hollow tube heater, the compression cylinder has a heating wall used to heat the tobacco rod portion from an outer peripheral side, the tobacco rod portion inserted in the compression cylinder is defined so as to be compressed by an inner wall surface of the compression cylinder,
a location of the air hole provided in the mouthpiece portion is defined so as to coincide with a location of an insertion port of the heating chamber when a distal end of the tobacco rod portion is inserted to a prescribed location of the heating chamber,
part of an outer surface of the tipping paper is coated with a lip-release material, and
of the outer surface of the tipping paper, a lip-release material region coated with the lip-release material is defined as a region located adjacent to the insertion port with respect to at least the heating wall when a distal end of the tobacco rod portion is inserted to the prescribed location of the heating chamber.

11. The heat-not-burn tobacco stick according to claim 10, wherein the prescribed location is a deepest location of the heating chamber.

12. The heat-not-burn tobacco stick according to claim 10, wherein the lip-release material region is a region located between the air hole and a mouthpiece end of the mouthpiece portion.

13. The heat-not-burn tobacco stick according to claim 10, wherein the cross-sectional area of the tobacco rod portion is defined such that the cross-sectional area after insertion into the compression cylinder is greater than or equal to 60% and less than or equal to 99% of the cross-sectional area before insertion into the compression cylinder.

14. The heat-not-burn tobacco stick according to claim 10, wherein a length of the tobacco rod portion is defined such that a whole of the tobacco rod portion and part of the mouthpiece portion are compressed by the inner wall surface of the compression cylinder in a state where the heat-not-burn tobacco stick is inserted to a prescribed location of the heating chamber.

15. The heat-not-burn tobacco stick according to claim 14, wherein a cross-sectional area of the mouthpiece portion is defined such that the cross-sectional area after insertion into the compression cylinder is greater than or equal to 60% and less than or equal to 99% of the cross-sectional area before insertion into the compression cylinder.
